(19) United States
(12) Patent Application Publication
(10) Pub. No.: US 2024/0283537 A1
(43) Pub. Date: Aug. 22, 2024

(54) TRANSMITTER, TRANSMISSION DEVICE, COMMUNICATION DEVICE, AND COMMUNICATION SYSTEM

(71) Applicant: NEC Corporation, Tokyo (JP)

(72) Inventors: Hisashi MIZUMOTO, Tokyo (JP); Fujio Okumura, Kanagawa (JP)

(73) Assignee: NEC Corporation, Tokyo (JP)

(21) Appl. No.: 18/411,126

(22) Filed: Jan. 12, 2024

(30) Foreign Application Priority Data
Feb. 17, 2023 (JP) 2023-023184

(51) Int. Cl. H04B 10/25; H04B 10/516; H04B 10/60

(52) U.S. Cl. CPC H04B 10/25; H04B 10/516; H04B 10/60

(57) ABSTRACT

Provided is a transmitter that includes a light source including a plurality of emitters, a spatial optical modulator including a modulating part in which a plurality of modulation regions to be irradiated with illumination light derived from light emitted from each of the plurality of emitters are set, and a reflector including a reflective surface that is irradiated with the modulated light modulated in each of the plurality of modulation regions and reflects the modulated light modulated in each of the plurality of modulation regions in a certain direction in a horizontal plane.

This application is based upon and claims the benefit of priority from Japanese Patent Application No. 2023-023184, filed on Feb. 17, 2023, the disclosure of which is incorporated herein in its entirety by reference.

### TECHNICAL FIELD

The present disclosure relates to a transmitter, a transmission device, a communication device, and a communication system.

### BACKGROUND ART

In space optical communication, optical signals (hereinafter, also referred to as a “spatial optical signal”) propagating in space are transmitted and received without using a medium such as an optical fiber. In order to transmit the spatial optical signal in a wide range, it is preferable that an incidence angle of incident light is as large as possible. For example, when an optical transmission device including a phase modulation-type spatial optical modulator is used, the incidence angle can be increased by controlling a pattern set in a modulating part of the spatial optical modulator. If the spatial optical signal can be transmitted in multiple directions around the optical transmission device, a communication network using the spatial optical signal can be constructed.

In general spatial optical communication, an adjustment mechanism for adjusting a transmission/reception direction of the spatial optical signal is required in order to support a communication angle of 360 degrees. In a case in which the direction of the communication target is unknown, it is necessary to check the direction of the communication target with naked eyes or perform adjustment while performing communication mutually between the communication device and the communication target. Therefore, it takes a lot of labor and time to install the communication device that transmits and receives the spatial optical signal.

PTL 1 (JP 2018-026095 A) discloses an optical transmission/reception device for transmitting and receiving optical signals between traveling vehicles. The device disclosed in PTL 1 includes a light emitting unit, a light receiving unit, and an omnidirectional optical component. The device disclosed in PTL 1 is configured in such a way that an optical axis at which an optical signal transmitted from the light emitting unit is incident on the omnidirectional optical component is the same as an optical axis at which an optical signal being transmitted from another vehicle and incident on the omnidirectional optical component is emitted from the omnidirectional optical component. The device disclosed in PTL 1 performs omnidirectional transmission and reception to and from an unspecified vehicle by transmitting the optical signal in all directions being external substantially horizontal directions through the omnidirectional optical component and receiving the optical signal transmitted from other vehicles in all directions being substantially horizontal directions. In addition, the device disclosed in PTL 1 performs one-to-one communication with specific another vehicle by transmitting the optical signal transmitted from the single light emitting element to the specific another vehicle through the omnidirectional optical component and receiving the optical signal transmitted from the specific another vehicle.

In the technique disclosed in PTL 1, the communication target is detected through omnidirectional transmission and reception, and individual optical signals (individual signals) are transmitted toward the detected single communication target. In the technique disclosed in PTL 1, among pixels of an image projected by a projector of the light emitting unit, a pixel associated with an optical signal for a specific communication target is used to transmit the optical signal for the specific communication target. In the technique disclosed in PTL 1, since the intensity of the optical signal for the specific communication target decreases, it is difficult to continue communication.

It is an object of the present disclosure to provide a transmitter or the like capable of consecutively transmitting spatial optical signals for spatial optical communication to the communication target arranged in a certain direction in a horizontal plane.

### SUMMARY

A transmitter according to an aspect of the present disclosure includes a light source including a plurality of emitters, a spatial optical modulator including a modulating part in which a plurality of modulation regions to be irradiated with illumination light derived from light emitted from each of the plurality of emitters are set, and a reflector including a reflective surface that is irradiated with modulated light modulated in each of the plurality of modulation regions and reflects the modulated light modulated in each of the plurality of modulation regions in a certain direction in the horizontal plane.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device according to the present disclosure;

FIG. 2 is a bottom view of a reflector of a transmitter included in the transmission device according to the present disclosure:

FIG. 3 is a conceptual diagram illustrating an example of a configuration of a light source included in the transmission device according to the present disclosure:

FIG. 4 is a conceptual diagram illustrating an example of the configuration of the light source included in the transmission device according to the present disclosure:

FIG. 5 is a conceptual diagram illustrating an example of the configuration of the light source included in the transmission device according to the present disclosure:

FIG. 6 is a conceptual diagram illustrating an example of the configuration of the light source included in the transmission device according to the present disclosure:

FIG. 7 is a conceptual diagram illustrating an example of a modulation region set in a modulating part of a spatial optical modulator included in the transmission device according to the present disclosure:

FIG. 8 is a conceptual diagram for describing a ghost image irradiated to a reflector included in the transmission device according to the present disclosure;

FIG. 9 is a conceptual diagram for describing an example of a ghost cancellation technique in a first modification of the present disclosure;

FIG. 10 is a conceptual diagram for describing an example of the ghost cancellation technique in the first modification of the present disclosure:

FIG. 11 is a conceptual diagram for describing an example of the ghost cancellation technique in the first modification of the present disclosure;

FIG. 12 is a conceptual diagram for describing a ghost image irradiated to the reflector included in the transmission device according to the present disclosure:

FIG. 13 is a conceptual diagram illustrating an example of a configuration of a transmitter according to a second modification of the present disclosure;

FIG. 14 is a bottom view of a reflector of a transmitter according to the second modification of the present disclosure:

FIG. 15 is a conceptual diagram illustrating an example of a configuration of a transmitter according to a third modification of the present disclosure;

FIG. 16 is a bottom view of a reflector of the transmitter according to the third modification of the present disclosure:

FIG. 17 is a conceptual diagram illustrating an example of the configuration of the transmission device according to the present disclosure:

FIG. 18 is a conceptual diagram illustrating an example of a configuration of a transmission device according to a fourth modification of the present disclosure:

FIG. 19 is a bottom view of a reflector of a transmitter included in the transmission device according to the fourth modification of the present disclosure:

FIG. 20 is a conceptual diagram for describing a ghost image irradiated to a reflector included in the transmission device according to the fourth modification of the present disclosure:

FIG. 21 is a bottom view of a reflector of a transmitter according to a fifth modification of the present disclosure:

FIG. 22 is a conceptual diagram illustrating an example of a configuration of a transmission device according to a sixth modification of the present disclosure:

FIG. 23 is a bottom view of a reflector of the transmitter according to the sixth modification of the present disclosure;

FIG. 24 is a block diagram illustrating an example of a configuration of a communication device according to the present disclosure:

FIG. 25 is a conceptual diagram illustrating an example of a configuration of a reception device included in the communication device according to the present disclosure:

FIG. 26 is a conceptual diagram illustrating an example of a configuration of a communication device according to an application example of the present disclosure:

FIG. 27 is a conceptual diagram illustrating an example of a communication system including a communication device according to an application example of the present disclosure;

FIG. 28 is a conceptual diagram illustrating an example of a configuration of a transmitter according to the present disclosure; and

FIG. 29 is a block diagram illustrating an example of a hardware configuration that executes processes and control according to the present disclosure.

### Example Embodiment

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, directions of arrows in the drawings are merely examples, and not intended to limit directions of light or signals. In addition, lines indicating a trajectory of light in the drawings are conceptual and not intended to accurately indicate an actual traveling direction or status of light. For example, in the drawings, a change in a traveling direction or a status of light caused by refraction, reflection, diffusion, or the like at an interface between air and a substance may be omitted, or a light flux may be indicated by a single line. In addition, cross sections may not be hatched due to illustration of an example of a light path, a complicated configuration, or the like.

### First Example Embodiment

First, a transmission device according to a first example embodiment will be described with reference to the drawings. The transmission device of the present example embodiment is applied to spatial optical communication for transmitting and receiving optical signals (hereinafter, also referred to as a “spatial optical signal”) propagating in space. The transmission device of the present example embodiment may be used for the purpose other than spatial optical communication as long as the transmission device is used for transmitting light propagating in space. The drawings used in the description of the present example embodiment are conceptual and not intended to accurately depict an actual structure.

### Configuration

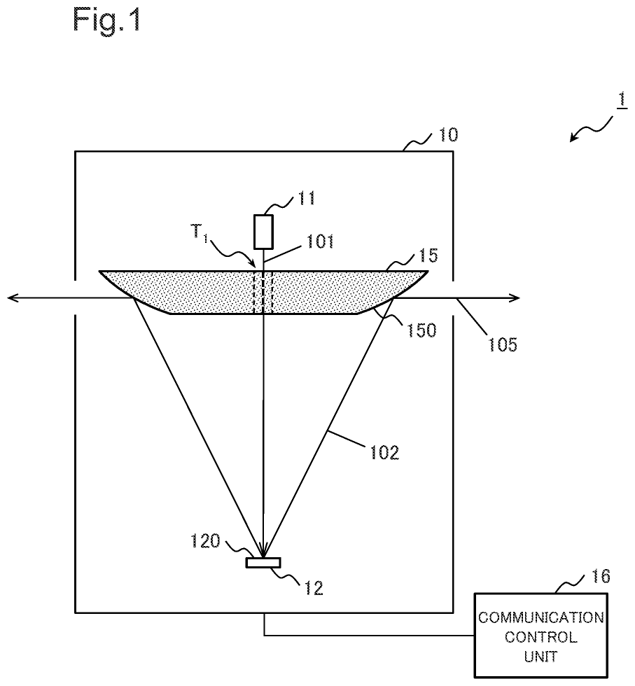

FIG. 1 is a conceptual diagram illustrating an example of a configuration of a transmission device 1 according to the present disclosure. The transmission device 1 includes a transmitter 10 and a communication control unit 16. FIG. 1 is a diagram illustrating an internal configuration of the transmitter 10 viewed from the side. The transmitter 10 is stored in a housing (not illustrated) in which an opening for transmitting a spatial optical signal is formed. The transmitter 10 includes a light source 11, a spatial optical modulator 12, and a reflector 15. FIG. 1 is a conceptual diagram and not intended to accurately depict a shape of each component, a positional relationship between components, traveling of light, or the like. The configuration of FIG. 1 may be arranged in an upside-down manner.

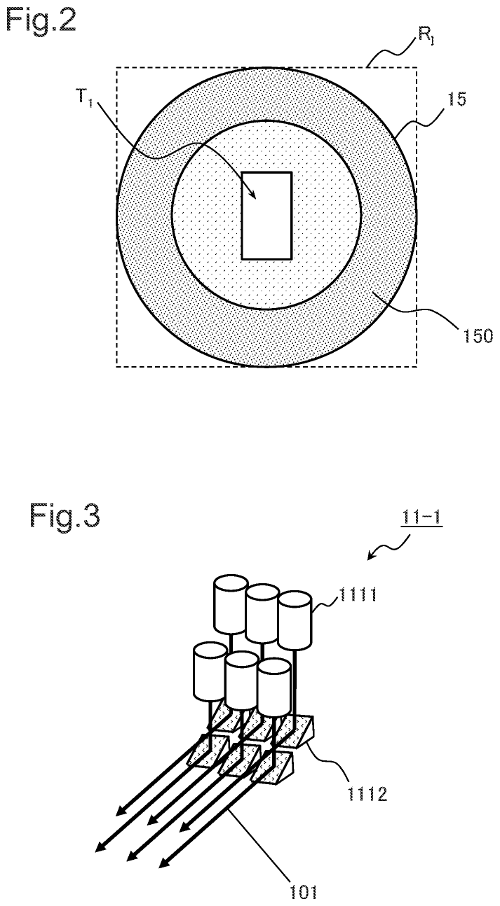

FIG. 2 is a conceptual diagram of the reflector 15 viewed from the bottom. In FIG. 2, an example of an outer edge representing an image forming range R₁ of a modulated light 102 is indicated by a broken line. A through hole T₁ through which illumination light 101 emitted from the light source 11 passes is formed in the reflector 15. In the example of FIG. 2, the opening shape of the through hole T₁ is rectangular, but the opening shape of the through hole T₁ may not be rectangular. The modulating part 120 of the spatial optical modulator 12 irradiated with the illumination light 101 having passed through the through hole T₁. The modulated light 102 modulated by the modulating part 120 of the spatial optical modulator 12 travels toward the image forming range R₁. Among the modulated light 102 traveling toward the image forming range R₁, the modulated light 102 with which a reflective surface 150 of the reflector 15 is irradiated is reflected by the reflective surface 150 of the reflector 15 and projected as projection light 105.

The light source 11 emits the illumination light 101. The emission surface of the light source 11 faces the modulating part 120 of the spatial optical modulator 12 via the through hole T₁ of the reflector 15. The modulating part 120 of the spatial optical modulator 12 is irradiated with the illumination light 101 emitted from the light source 11. The light source 11 may be disposed inside the through hole T₁ of the reflector 15. The light source 11 may be disposed between the reflector 15 and the spatial optical modulator 12. In this case, the through hole T₁ may not be formed in the reflector 15. FIG. 3 is a conceptual diagram illustrating an example of a configuration of the light source 11 (a light source 11-1). FIG. 3 is a conceptual diagram of an internal configuration of the light source 11-1. In the example of FIG. 3, an emission direction of the illumination light 101 is a left-oblique downward direction. The light source 11-1 is arranged to emit the illumination light 101 downward as illustrated in FIG. 1. The light source 11-1 includes a plurality of emitters 1111 and a plurality of reflecting mirrors 1112. FIG. 3 illustrates an example in which six emitters 1111 are arranged. The number of the emitters 1111 included in the light source 11-1 is not limited to six. The number of the emitters 1111 may be less than six or may be seven or more.

The reflecting mirror 1112 is a prismatic element whose reflective surface has an inclination angle of 45 degrees. Each of the plurality of emitters 1111 is associated with any one of the plurality of reflecting mirrors 1112. The emission surfaces of the plurality of emitters 1111 face the reflective surfaces of the associated reflecting mirrors 1112. The reflective surfaces of the plurality of reflecting mirrors 1112 face the modulating part 120 of the spatial optical modulator 12.

Each of the plurality of emitters 1111 emits the illumination light 101 under control of a communication control unit 16. Each of the plurality of emitters 1111 is associated with any one of the plurality of modulation regions set in the modulating part 120 of the spatial optical modulator 12 via the associated reflective surface of the reflecting mirror 1112. Each of the plurality of emitters 1111 emits the illumination light 101 toward the associated modulation region.

The emitter 1111 included in the light source 11-1 emits laser beams with a predetermined wavelength band under the control of the communication control unit 16. The wavelength of the laser beams emitted from the emitter 1111 is not particularly limited and may be selected in accordance with the purpose. For example, the emitter 1111 emits laser beams with visible or infrared wavelength bands. For example, when near infrared rays of 800 to 1000 nanometers (nm) are used, a laser class can be given as compared with visible light, so the sensitivity can be improved as compared with visible light. For example, a laser beam source having a higher output than near-infrared rays of 800 to 1000 nm can be implemented using infrared rays with a wavelength band of 1.55 micrometers (μm). An aluminum gallium arsenide phosphide (AlGaAsP)-based laser beam source, an indium gallium arsenide (InGaAs)-based laser beam source, or the like can be used as the laser beam source that emits infrared rays with a wavelength band of 1.55 μm. As the wavelength of the laser beams increases, it is possible to increase the diffraction angle and set the higher energy.

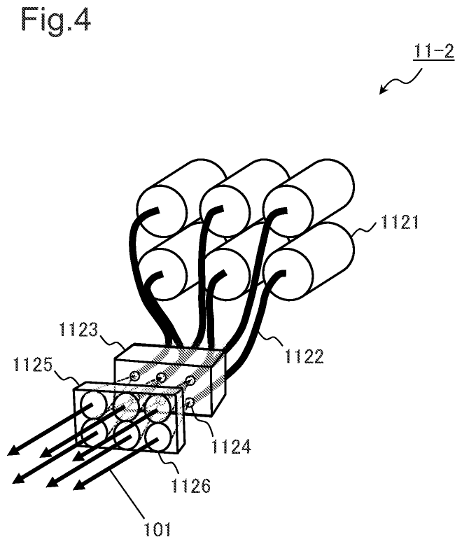

FIG. 4 is a conceptual diagram illustrating an example of the configuration of the light source 11 (a light source 11-2). The light source 11-2 has a configuration of a fiber array-type laser. FIG. 4 is a conceptual diagram of an internal configuration of the light source 11-2. In the example of FIG. 4, an emission direction of the illumination light 101 is a left-oblique downward direction. The light source 11-2 is arranged to emit the illumination light 101 downward as illustrated in FIG. 1. The light source 11-2 includes a plurality of emitters 1121, a plurality of optical fibers 1122, a fiber binder 1123, and a micro collimator array 1125. FIG. 4 illustrates an example in which six emitters 1121 are arranged. The number of the emitters 1121 included in the light source 11-2 is not limited to six. The number of the emitters 1121 may be less than six or may be seven or more.

For example, the emitter 1121 is a laser beam source that intermittently oscillates laser output by pulse oscillation such as a direct modulation technique, an external modulation technique, a Q-switch technique, or a mode tuning technique. For example, the emitter 1121 may be a continuous wave (CW) laser beam source that consecutively oscillates laser output. The emitter 1121 emits laser beams as a direct current is supplied from a direct current source (not illustrated). The laser beams emitted from the emitter 1121 travel toward the fiber binder 1123 through the optical fiber 1122. Each of the plurality of optical fibers 1122 is associated with any one of the plurality of emitters 1121. The optical fiber 1122 is an optical waveguide that guides the laser beams emitted from the emitter 1121 to the fiber binder 1123. A material of the optical fiber 1122 is selected depending on the wavelength band of the laser beams emitted from the emitter 1121.

The fiber binder 1123 is a node at which the plurality of optical fibers 1122 are bundled. The laser beams enter the fiber binder 1123 through the plurality of optical fibers 1122. The fiber binder 1123 modulates the incident laser beams. For example, the fiber binder 1123 may include a Mach-Zehnder-type optical modulator. For example, the fiber binder 1123 may include an electric field absorption-type optical modulator.

The micro collimator array 1126 has a configuration in which micro-optics is applied to a plurality of micro collimators. Each of the plurality of micro collimators is associated with any one of the plurality of optical fibers 1122. The beams that pass through the associated optical fiber 1122 and then are modulated by the fiber binder 1123 are incident on the micro collimator. The emission surface of the micro collimator array 1126 faces the modulating part 120 of the spatial optical modulator 12. The micro collimator converts the incident beams into illumination light 101. The converted illumination light 101 is emitted from the light source 11-2 toward the modulation region associated with each of the plurality of emitters 1121. When a fiber array-type laser is used, since the plurality of emitters 1121 can be arranged at positions apart from the spatial optical modulator 12, thermal interference hardly occurs even though emission part of light and the spatial optical modulator 12 are brought close to each other.

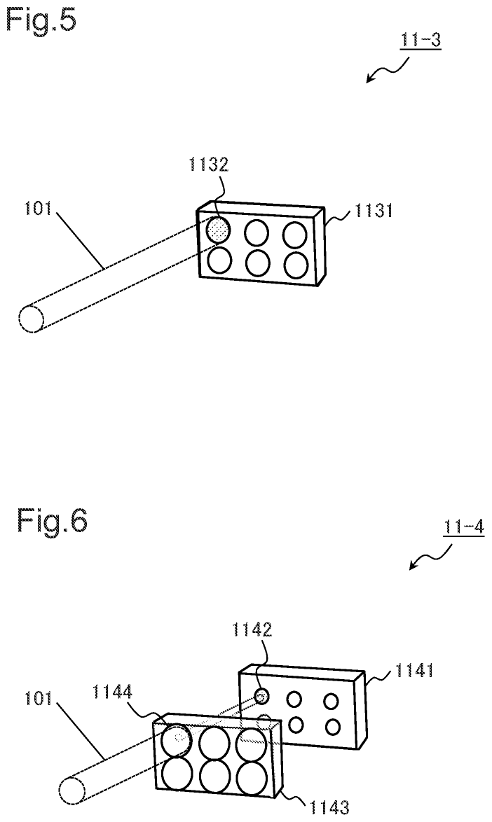

FIG. 5 is a conceptual diagram illustrating an example of the configuration of the light source 11 (a light source 11-3). The light source 11-3 includes a surface emission-type laser. For example, the light source 11-3 is implemented by a photonic crystal surface emitting laser (PCSEL)-type laser. The PCSEL-type laser emits laser beams of circular narrow radiation and thus needs no collimator. In the example of FIG. 5, the emission direction of the illumination light 101 is a left-oblique downward direction. The light source 11-3 is arranged to emit the illumination light 101 downward as illustrated in FIG. 1. The light source 11-3 includes a surface emitting element 1131 having a plurality of emitting units 1132 that are arranged in an array form. FIG. 5 illustrates an example in which six emitting units 1132 are arranged. The number of the emitting units 1132 included in the light source 11-3 is not limited to six. The number of the emitting units 1132 may be less than six or may be seven or more.

Each of the plurality of emitting units 1132 is associated with any one of the plurality of modulation regions set in the modulating part 120 of the spatial optical modulator 12. The illumination light 101 emitted from each of the plurality of emitting units 1132 travels toward the associated modulation region.

FIG. 6 is a conceptual diagram illustrating an example of the configuration of the light source 11 (a light source 11-4). The light source 11-4 includes a surface emission-type laser. For example, the light source 11-4 is implemented by a PCSEL-type laser. In the example of FIG. 6, the emission direction of the illumination light 101 is a left-oblique downward direction. The light source 11-4 is arranged to emit the illumination light 101 downward as illustrated in FIG. 1. The light source 11-4 includes a surface emitting element 1141 and a microbeam expander 1143. The surface emitting element 1141 has an emission surface in which a plurality of emitting units 1142 are arranged in an array form. The microbeam expander 1143 has a configuration in which a plurality of light expanding units 1144 is arranged in an array form. FIG. 6 illustrates an example in which six emitting units 1142 are arranged. The number of the emitting units 1142 included in the light source 11-4 is not limited to six. The number of the emitting units 1142 may be less than six or may be seven or more.

Each of the plurality of emitting units 1142 is associated with any one of the plurality of light expanding units 1144 included in the microbeam expander 1143. The laser beams emitted from each of the plurality of emitting units 1142 travel toward any one of the light expanding units 1144 included in the microbeam expander 1143.

The microbeam expander 1143 is an optical element that expands an irradiation diameter of the laser beams emitted from the surface emitting element 1141. The microbeam expander 1143 is made of a material having high transmittance for the laser beams emitted from the surface emitting element 1141. For example, the light expanding unit 1144 has a structure in which a plurality of lenses are combined. Each of the plurality of light expanding units 1144 constituting the microbeam expander 1143 is associated with any one of the plurality of emitting units 1142. Each of the plurality of light expanding unit 1144 is associated with any one of the plurality of modulation regions set in the modulating part 120 of the spatial optical modulator 12. The laser beams emitted from the associated emitting unit 1142 are incident on the light expanding unit 1144. The illumination light 101 expanded by the light expanding unit 1144 travels toward the modulation region associated with the light expanding unit 1144.

The spatial optical modulator 12 is a phase modulation-type spatial optical modulator. The spatial optical modulator 12 includes the modulating part 120. A plurality of modulation regions are set in the modulating part 120. The number of modulation regions set in the modulating part 120 is set in accordance with the number of emitters included in the light source 11.

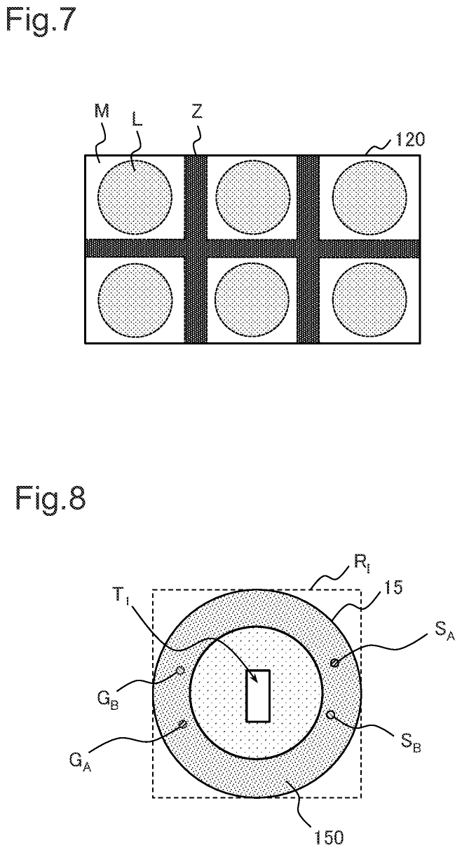

FIG. 7 is a conceptual diagram illustrating an example of a plurality of modulation regions M set in the modulating part 120. The modulation regions M are set in the modulating part 120 in accordance with the number of emitters included in the light source 11. In the example of FIG. 7, the six modulation regions M are set to be associated with the examples of FIGS. 3 to 6. A dead zone Z is set between the adjacent modulation regions M. A black stripe-shaped phase image is set in the dead zone Z. The dead zone Z may be set to divide the modulating part 120 in a certain shape instead of dividing the modulating part 120 in a lattice form.

Each of the plurality of modulation regions M is associated with any one of the plurality of emitters included in the light source 11. Each of the plurality of modulation regions M is irradiated with the illumination light 101 derived from the laser beams emitted from the associated emitter. FIG. 7 illustrates an irradiation range L of the illumination light 101 with which the modulation region M is irradiated. In the example of FIG. 7, the irradiation range L has a circular shape but may have a circular shape such as an elliptical shape.

Each of the plurality of modulation regions M is irradiated with the illumination light 101 derived from the laser beams emitted from the emitter associated with the modulation region M. The association relationship between the modulation region M and the emitter is not particularly limited as long as the illumination light 101 derived from the laser beams emitted from the emitter is incident on the modulation surface of the modulation region M.

A pattern (also referred to as a “phase image”) related to an image displayed by the projection light 105 is set in each of the plurality of modulation regions M in accordance with the control of the communication control unit 16. The illumination light 101 incident on each of the plurality of modulation regions M set in the modulating part 120 is modulated in accordance with the pattern (phase image) set in each of the plurality of modulation regions M. The modulated light 102 modulated in each of the plurality of modulation regions M travels toward the reflective surface 150 of the reflector 15.

The modulation region M is divided into a plurality of regions (which is also referred to as tiling). For example, the modulation region M is divided into regions (also referred to as “tiles”) having a desired aspect ratio. The phase image is allocated to each of the plurality of tiles set in the modulation region M. Each of the plurality of tiles is configured with a plurality of pixels. The phase image associated with the projected image is set in each of the plurality of tiles. The phase image is tiled in each of the plurality of tiles allocated to the modulation region M. For example, the phase image generated in advance is set in each of the plurality of tiles. When the modulation region M is irradiated with the illumination light 101 in a state in which the phase images are set in the plurality of tiles, the modulated light 102 that forms the image associated with the phase image of each tile is emitted. A clearer image can be displayed as the number of tiles set in the modulation region M increases, whereas the resolution decreases as the number of pixels of each tile decreases. Therefore, the size and the number of tiles set in the modulation region M are set in accordance with the purpose.

For example, the spatial optical modulator 12 is implemented by a spatial optical modulator employing a ferroelectric liquid crystal, a homogeneous liquid crystal, a vertical alignment liquid crystal, or the like. For example, the spatial optical modulator 12 can be implemented by liquid crystal on silicon (LCOS). The spatial optical modulator 12 may be implemented by a micro electro mechanical system (MEMS). The phase modulation-type spatial optical modulator 12 can cause energy to be concentrated on a portion of an image by an operation for sequentially switching the portion on which the projection light 105 is projected. Therefore, in the case in which the phase modulation-type spatial optical modulator 12 is used, a brighter image can be displayed than in other techniques when the outputs of the emitters included in the light source 11 are the same.

The reflector 15 is a reflector having a curved reflective surface 150. The reflector 15 has a circular shape in a planar view. The reflector 15 has a circular upper surface (first surface) having a first radius and a circular lower surface (second surface) having a second radius smaller than the first radius. The center of the circle on the upper surface coincides with the center of the circle on the lower surface. The side surface of the reflector 15 has a smooth curved surface formed from the upper surface toward the lower surface. The side surface (curved surface) of the reflector 15 is the reflective surface 150. That is, the reflector 15 is a reflecting mirror having the curved reflective surface 150. A through hole T₁ penetrating from the upper surface to the lower surface is formed in the center of the reflector 15. In the case in which the light source 11 is disposed below the reflector 15, the opening may not be formed in the reflector 15.

The reflective surface 150 of the reflector 15 is adjusted to have an angle according to the projection direction of the projection light 105. The reflective surface 150 of the reflector 15 has a curvature according to the projection angle of the projection light 105. For example, the curvature of the reflective surface 150 of the reflector 15 is adjusted in such a way that the projection angle of the projection light 105 becomes about 6 degrees. The shape of the reflective surface 150 of the reflector 15 is not limited as long as the curved portion is included. For example, the reflective surface 150 of the reflector 15 may be a free curved surface or a spherical surface. For example, the reflective surface 150 of the reflector 15 may not be a single curved surface but may have a shape in which a plurality of curved surfaces are combined. Furthermore, the reflective surface 150 may be a plane surface. In the case in which the reflective surface 150 is a plane surface, the adjustment range of the projection angle of the projection light 105 is narrower than in the case in which the reflective surface 150 is a curved surface. In the case in which the reflective surface 150 is a plane surface, the projection light 105 reaches a far place because the spread is smaller than in the case in which the reflective surface 150 is a curved surface. For example, the reflective surface 150 of the reflector 15 may have a shape in which a curved surface and a plane surface are combined. Furthermore, a lens (not illustrated) may be arranged at the stage following the reflector 15 in order to limit the spread of the projection light 105.

The reflector 15 is arranged between the light source 11 and the spatial optical modulator 12. The reflective surface 150 is irradiated with the modulated light 102 modulated by the modulating part 120. The modulated light 102 with which the reflective surface 150 is irradiated is reflected by reflective surface 150. The light (projection light 105) reflected by the reflective surface 150 is enlarged at an enlargement ratio according to the curvature of the reflective surface 150 and projected. The projection light 105 spreads while traveling away from the transmission device 1.

The reflective surface 150 of the reflector 15 is oriented in a certain direction in the horizontal plane. Therefore, the transmission device 1 can control the pattern (phase image) set in the modulating part 120 of the spatial optical modulator 12 in such a way that the projection light 105 is projected in a certain direction in the horizontal plane. Furthermore, the transmission device 1 can associate the plurality of modulation regions M set in the modulating part 120 with different directions and then simultaneously transmit the projection light 105 (spatial optical signals) toward the communication targets arranged in a plurality of directions.

In the configuration of FIG. 1, the modulated light 102 modulated by the modulating part 120 of the spatial optical modulator 12 travels toward the reflective surface 150 of the reflector 15. The modulated light 102 may be reflected at multiple stages by using at least one folding mirror and travel toward the reflective surface 150 of the reflector 15. For example, a first folding mirror of an annular shape centered on the optical path of the illumination light 101 is arranged on the second surface of the reflector 15. Then, a second folding mirror of an annular shape centered on the spatial optical modulator 12 is arranged in a plane in which the spatial optical modulator 12 is arranged. The radius of the first folding mirror is smaller than the radius of the second folding mirror. As described above, it is possible to implement the configuration in which the modulated light 102 modulated by the modulating part 120 of the spatial optical modulator 12 is sequentially reflected by the first folding mirror and the second folding mirror, and then reaches the reflective surface 150 of the reflector 15. The folding mirror may be configured with three or more mirrors. With the configuration described above, the interval between the spatial optical modulator 12 and the reflector 15 in the direction of the diameter of the reflector 15 can be reduced, so the transmitter 10 can be more compacted in the thickness direction.

The communication control unit 16 (communication control means) controls the light source 11 and the spatial optical modulator 12. For example, the communication control unit 16 is implemented by a microcomputer including a processor and a memory. The communication control unit 16 sets the phase image associated with the image to be projected in the modulating part 120. The communication control unit 16 sets the phase image associated with the image to be projected in the modulation region set in the modulating part 120 of the spatial optical modulator 12. The phase image of the image to be projected may be stored in a storage unit (not illustrated) in advance. The shape or the size of the image to be projected is not particularly limited.

The communication control unit 16 controls the spatial optical modulator 12 in such a way that a parameter for determining a difference between a phase of the illumination light 101 with which the modulating part 120 is irradiated and a phase of the modulated light 102 to be reflected by the modulating part 120 changes. For example, the parameter is a value related to optical characteristics such as a refractive index or an optical path length. For example, the communication control unit 16 adjusts the refractive index of the modulating part 120 by changing a voltage applied to the modulating part 120 of the spatial optical modulator 12. The phase distribution of the illumination light 101 with which the modulating part 120 of the phase modulation-type spatial optical modulator 12 is irradiated is modulated in accordance with the optical characteristics of the modulating part 120. A technique of driving the spatial optical modulator 12 by the communication control unit 16 is determined in accordance with a modulation scheme of the spatial optical modulator 12.

The communication control unit 16 drives the light source 11 in a state in which the phase image associated with the image to be displayed is set in the modulating part 120 of the spatial optical modulator 12. As a result, the modulating part 120 is irradiated with the illumination light 101 emitted from the light source 11 in the state in which the phase image is set in the modulating part 120. The illumination light 101 with which the modulating part 120 is irradiated is modulated by the modulating part 120. The modulated light 102 modulated by the modulating part 120 travels toward the reflective surface 150 of the reflector 15.

Furthermore, the communication control unit 16 modulates the illumination light 101 emitted from the light source 11 for communication with the communication target (not illustrated). In communication, the communication control unit 16 controls a timing at which the illumination light 101 is emitted from the light source 11 in a state in which the phase image for communication is set in the modulating part 120 of the spatial optical modulator 12. The illumination light 101 is modulated by this control. The modulation pattern of the illumination light 101 in the communication is arbitrarily set. In addition to the communication control unit 16, a communication unit (not illustrated) is added. The communication control unit 16 may be configured to control the light source 11 and the spatial optical modulator 12 in accordance with conditions set by the communication unit.

### Modifications

Next, modifications of the transmission device 1 of the present example embodiment will be described with reference to the drawings. Hereinafter, modifications for preventing a spatial optical signal derived from a ghost image of a spatial optical signal to be transmitted from being decoded will be described. The following modifications are examples of preventing the spatial optical signal derived from the ghost image from being decoded by changing the structure of the reflector 15.

### First Modification

The first modification is an example for causing the spatial optical signal derived from the ghost image to be undecodable by superimposing disturbance light on the ghost image.

FIG. 8 is a conceptual diagram for describing an example of the ghost image that may occur in transmission of the spatial optical signal using the transmitter 10. FIG. 8 is a bottom view of the reflector 15 viewed from the bottom. An irradiation position (irradiation light S_{A} and irradiation light S_{B}) of the modulated light 102 serving as the spatial optical signal (the projection light 105) to be transmitted is indicated on the reflective surface 150 of the reflector 15. An irradiation position of the ghost image (ghost light G_{A} and ghost light G_{B}) of the irradiation light (the irradiation light S_{A} and the irradiation light S_{B}) is indicated on the reflective surface 150 of the reflector 15. The ghost image of the irradiation light S_{A} is the ghost light G_{A}. The ghost image of the irradiation light S_{B} is the ghost light G_{B}. In the case of the example of FIG. 8, the spatial optical signal caused by the ghost image is also transmitted in addition to the spatial optical signal to be transmitted. In this case, when the spatial optical signal caused by the ghost image is received, the spatial optical signal to be transmitted may be decoded.

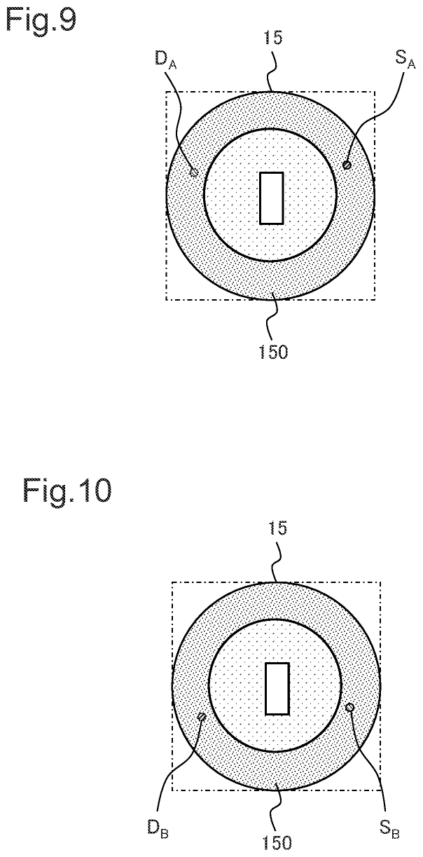

FIGS. 9 to 11 are conceptual diagrams for describing the first modification. FIGS. 9 to 11 are views of the reflector 15 viewed from the bottom. In the present modification, it is possible to cause the signal of the ghost image to be undecodable by forming a dot similar to the ghost image at the position of the ghost image. In the examples of FIGS. 9 to 11, a plurality of emitters is controlled to invalidate the ghost image.

FIG. 9 is an example of an image formed on the reflective surface 150 by a pattern (phase image) for irradiating the irradiation light S_{A}. In the example of FIG. 9, the reflective surface 150 is irradiated with the irradiation light S_{A} serving as the spatial optical signal to be transmitted. In the example of FIG. 9, the position of the ghost light G_{A} that is the ghost image of the irradiation light S_{B} serving as the spatial optical signal to be transmitted is irradiated with disturbance light D_{A}. The disturbance light D_{A} is irradiated with intensity similar to the ghost light G_{A} which is the ghost image of the irradiation light S_{B}.

FIG. 10 is an example of an image formed on the reflective surface 150 by a pattern (phase image) for irradiating the irradiation light S_{B}. In the example of FIG. 10, the reflective surface 150 is irradiated with the irradiation light S_{B} serving as the spatial optical signal to be transmitted. In the example of FIG. 10, the position of the ghost light G_{B} that is the ghost image of the irradiation light S_{A} serving as the spatial optical signal to be transmitted is irradiated with disturbance light D_{B}. The disturbance light D_{B} is irradiated with intensity similar to the ghost light G_{B} which is the ghost image of the irradiation light S_{B}.

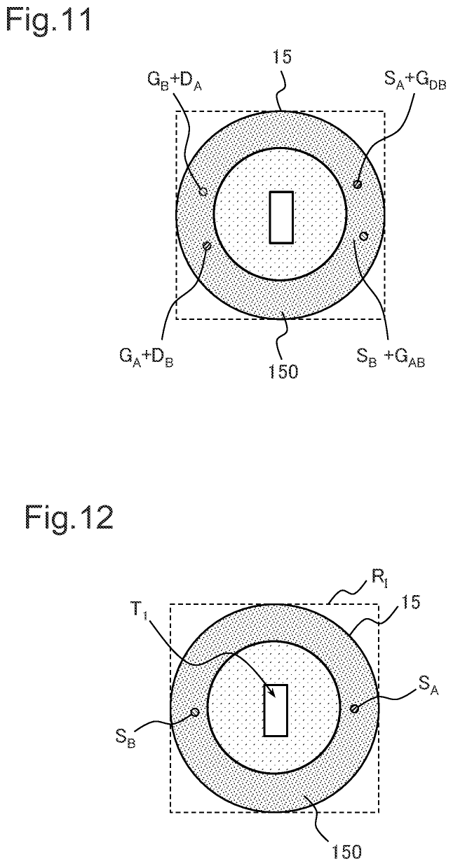

FIG. 11 is an example of an image formed on the reflective surface 150 by a pattern (phase image) obtained by combining the images of FIGS. 9 and 10. The reflective surface 150 is irradiated with the irradiation light S_{A} and the irradiation light S_{B} which are the spatial optical signals to be transmitted. Further, the reflective surface 150 is irradiated with the ghost light G_{A} and the ghost light G_{B} which are the ghost images of the irradiation light S_{A} and the irradiation light S_{B}. Furthermore, the reflective surface 150 is irradiated with the disturbance light D_{A} and the disturbance light D_{A} for causing the ghost light G_{A} and the ghost light G_{B} to be undecodable.

Ghost light G_{DB} that is a ghost image of the disturbance light D_{B} is formed at the position of the irradiation light S_{A}. Since the ghost light G_{DB} has weak intensity, the influence on the spatial optical signal derived from the irradiation light S_{A} is ignorable. Ghost light G_{AB} that is a ghost image of the disturbance light D_{A} is formed at the position of the irradiation light S_{B}. Since the ghost light G_{AB} has weak intensity, the influence on the spatial optical signal derived from the irradiation light S_{B} is ignorable. A described above, the disturbance light D_{A} and the disturbance light D_{B} do not influence the spatial optical signals derived from the irradiation light S_{A} and the irradiation light S_{B}.

The disturbance light D_{A} is formed at the position of the ghost light G_{A}. Therefore, the spatial optical signal derived by superimposing the signal of the ghost light G_{A} on the signal of the disturbance light D_{A} is superimposed on the spatial optical signal derived from the ghost light G_{A}. The disturbance light D_{B} is formed at the position of the ghost light G_{B}. Therefore, the spatial optical signal derived from the disturbance light D_{B} is superimposed on the spatial optical signal derived from the ghost light G_{B}. As described above, the spatial optical signals derived from the ghost light G_{A} and the ghost light G_{B} become undecodable due to the superimposition of the disturbance light D_{A} and the disturbance light D_{B}. FIGS. 9 to 11 illustrate examples of reducing the influence of the ghost when two signals are transmitted. In the case of transmitting a single signal, a position of the ghost light of the irradiation light serving as the spatial optical signal to be transmitted may be irradiated with the disturbance light for causing the ghost light to be undecodable. As a result, the spatial optical signal derived from the ghost light becomes undecodable. Although the ghost image of the ghost light is superimposed on the irradiation light, the influence on the spatial optical signal derived from the irradiation light is ignorable because the intensity of the ghost image is very weak.

### Second Modification

The second modification is an example for causing the spatial optical signal derived from the ghost image not to be transmitted using an additional reflector. The present modification is effective in the case in which two communication targets are arranged on the substantially same straight line with the communication device including the transmission device 1 interposed therebetween.

FIG. 12 is a conceptual diagram for describing an example of transmitting the spatial optical signal to two communication targets in a situation in which the two communication targets are arranged on the substantially same straight line with the communication device interposed therebetween. FIG. 12 is a bottom view of the reflector 15 viewed from the bottom. An irradiation position (irradiation light S_{A} and irradiation light S_{B}) of the modulated light 102 serving as the spatial optical signal (the projection light 105) to be transmitted is indicated on the reflective surface 150 of the reflector 15. The irradiation light S_{A} and the irradiation light S_{B} are in a point-symmetric positional relationship with respect to a center of a circle formed by the reflector 15. Therefore, the position of the irradiation light S_{B} is irradiated with the ghost light G_{A} which is a ghost image of the irradiation light S_{A}. The position of the irradiation light S_{A} is irradiated with the ghost light G_{B} which is a ghost image of the irradiation light S_{B}. In the case of the example of FIG. 12, the spatial optical signal derived from the ghost image is superimposed on the spatial optical signal to be transmitted and then transmitted. In this case, the spatial optical signal to be transmitted may become undecodable.

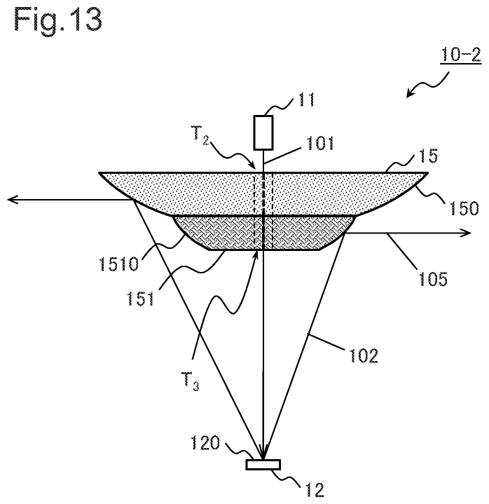

FIG. 13 is a conceptual diagram illustrating an example of a configuration of a transmitter 10-2 according to the second modification. FIG. 13 is a diagram illustrating an internal configuration of the transmitter 10-2 viewed from the side. The transmitter 10-2 includes a light source 11, a spatial optical modulator 12, a reflector 15, and an additional reflector 151. The light source 11 and the spatial optical modulator 12 have configurations similar to those illustrated in FIG. 1. Description of the light source 11 and the spatial optical modulator 12 is omitted. Furthermore, in the reflector 15 and the additional reflector 151, description of parts similar to those of the reflector 15 in FIG. 1 is omitted.

The reflector 15 has a configuration similar to the reflector 15. The reflector 15 is a reflector having a curved reflective surface 150. The reflector 15 has a circular shape in a planar view. The reflector 15 has a circular upper surface (first surface) having a first radius and a circular lower surface (second surface) having a second radius smaller than the first radius. The center of the circle on the upper surface coincides with the center of the circle on the lower surface. The side surface of the reflector 15 has a smooth curved surface formed from the upper surface toward the lower surface. The side surface (curved surface) of the reflector 15 is the reflective surface 150. That is, the reflector 15 is a reflecting mirror having the curved reflective surface 150. A through hole T₂ penetrating from the upper surface to the lower surface is formed in the center of the reflector 15. The additional reflector 151 is arranged below the reflector 15.

The additional reflector 151 is a reflector having a curved reflective surface 1510. The additional reflector 151 has a circular shape in a planar view. The additional reflector 151 has a circular upper surface (third surface) having a third radius and a circular lower surface (fourth surface) having a fourth radius smaller than the third radius. The center of the circle on the upper surface coincides with the center of the circle on the lower surface. The third radius is substantially the same as or smaller than the second radius. The side surface of the additional reflector 151 has a smooth curved surface formed from the upper surface toward the lower surface. A side surface (curved surface) of the additional reflector 151 is a reflective surface 1510 (additional reflective surface). That is, the additional reflector 151 is a reflecting mirror having the curved reflective surface 1510. A through hole T₃ penetrating from the upper surface to the lower surface is formed in the center of the additional reflector 151. The reflector 15 is arranged above the additional reflector 151. The through hole T₂ of the reflector 15 and the through hole T₃ of the additional reflector 151 are arranged to overlap each other. Due to this arrangement, the through hole T₂ and the through hole T₃ penetrate from the upper surface of the reflector 15 to the additional reflector 151. In the case in which the light source 11 is arranged below the additional reflector 151, an opening may not be formed in the reflector 15 and the additional reflector 151.

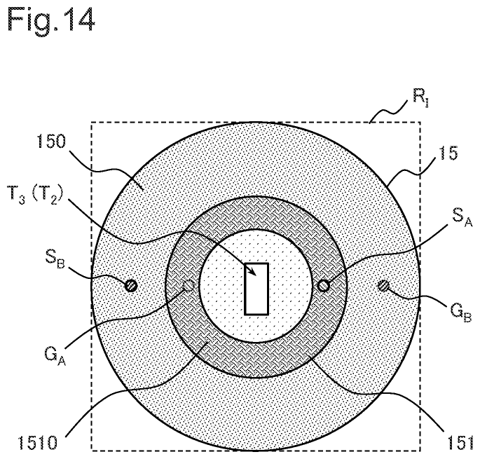

FIG. 14 is a conceptual diagram illustrating the reflector 15 and the additional reflector 151 viewed from the bottom. The reflective surface 1510 of the additional reflector 151 is irradiated with the irradiation light S_{A} serving as the spatial optical signal to be transmitted. The reflective surface 1510 of the additional reflector 151 is also irradiated with the ghost light G_{A} which is the ghost image of the irradiation light S_{A}. The reflective surface 150 of the reflector 15 is irradiated with the irradiation light S_{B} serving as the spatial optical signal to be transmitted. The reflective surface 150 of the reflector 15 is also irradiated with the ghost light G_{B} which is the ghost image of the irradiation light S_{B}. According to the configuration of the present modification, it is possible to transmit the spatial optical signal in which the influence of the ghost image is invalidated to the two communication targets arranged on the substantially same straight line with the communication device including the transmission device 1 interposed therebetween without adopting the technique of the first modification.

### Third Modification

A third modification is an example for causing the spatial optical signal derived from the ghost image not to be transmitted by changing the structure of the reflector 15. The present modification is an example in which the reflector 15 and the additional reflector 151 of the second modification are divided into halves and combined.

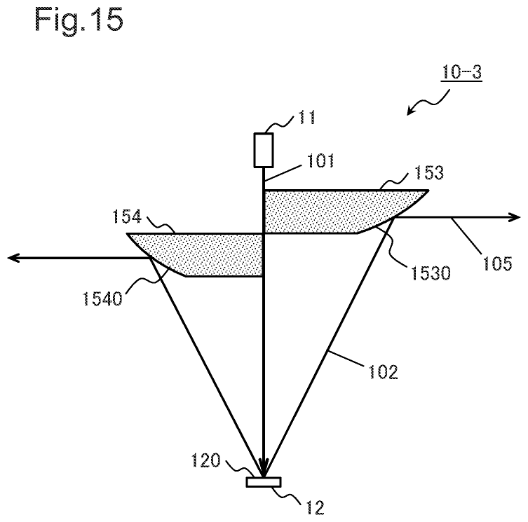

FIG. 15 is a conceptual diagram illustrating an example of a configuration of a transmitter 10-3 according to the third modification. FIG. 15 is a diagram illustrating an internal configuration of the transmitter 10-3 viewed from the side. The transmitter 10-3 includes a light source 11, a spatial optical modulator 12, a first reflector 153, and a second reflector 154. The light source 11 and the spatial optical modulator 12 have configurations similar to those illustrated in FIG. 1. Description of the light source 11 and the spatial optical modulator 12 is omitted. In the first reflector 153 and the second reflector 154, description of parts similar to those of the configuration of the second modification is omitted.

The first reflector 153 has an outer shape obtained by dividing the reflector 15 of the second modification into half. The first reflector 153 is a reflector having a curved reflective surface 1530. The first reflector 153 has a semicircular shape in a planar view: The first reflector 153 has a semicircular upper surface having a first radius and a semicircular lower surface having a second radius smaller than the first radius. The center of the semicircle of the upper surface coincides with the center of the semicircle of the lower surface. The outer side surface (a right side in FIG. 15) of the first reflector 153 has a smooth curved surface formed from the upper surface toward the lower surface. An outer side surface (curved surface) of the first reflector 153 is a reflective surface 1530. That is, the first reflector 153 is a reflecting mirror having the curved reflective surface 1530. An opening portion is formed in the center (the left side in FIG. 15) of the reflector 15. The shape of the opening portion is not particularly limited. The second reflector 154 is arranged below the first reflector 153.

The second reflector 154 has an outer shape obtained by dividing the additional reflector 151 of the second modification into half. The second reflector 154 is a reflector having a curved reflective surface 1540. The second reflector 154 has a semicircular shape in a planar view: The second reflector 154 has a semicircular upper surface having a third radius and a semicircular lower surface having a fourth radius smaller than the third radius. The center of the semicircle of the upper surface coincides with the center of the semicircle of the lower surface. The third radius is substantially the same as or smaller than the second radius. The side surface of the second reflector 154 has a smooth curved surface formed from the upper surface toward the lower surface. The side surface (curved surface) of the second reflector 154 is the reflective surface 1540. That is, the second reflector 154 is a reflecting mirror having the curved reflective surface 1540. An opening portion is formed in the center of the second reflector 154. The shape of the opening portion is not particularly limited. The first reflector 153 is arranged above the second reflector 154. In the case in which the light source 11 is arranged below the second reflector 154, an opening (an open region Z_{G}) may not be formed in the first reflector 153 and the second reflector 154.

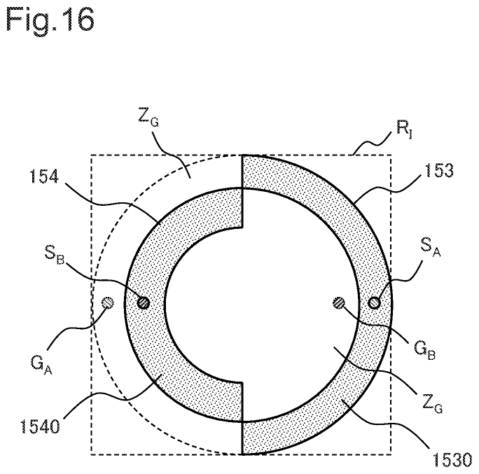

FIG. 16 is a conceptual diagram illustrating the first reflector 153 and the second reflector 154 viewed from the bottom. The reflective surface 1530 of the first reflector 153 is irradiated with the irradiation light S_{A} serving as the spatial optical signal to be transmitted. The reflective surface 1540 of the second reflector 154 is irradiated with the irradiation light S_{B} serving as the spatial optical signal to be transmitted. The open region Z_{G} is irradiated with the ghost light G_{A} which is the ghost image of the irradiation light S_{A}. The open region Z_{G} is irradiated with the ghost light G_{B} that is the ghost image of the irradiation light S_{B}. As illustrated in FIG. 15, only the spatial optical signals derived from the irradiation light S_{A} and the irradiation light S_{B} are transmitted.

The modifications described above are the examples of performing the ghost cancellation technique by superimposing the disturbance light on the ghost image or changing the structure of the reflector. By using a virtual lens, the ghost image can be reduced without taking a countermeasure as in the modifications. For example, the ghost cancellation technique according to the modification may be combined with a technique using a virtual lens.

As described above, the transmission device of the present example embodiment includes the transmitter and the communication control unit. The transmitter includes a light source, a spatial optical modulator, and a reflector. The light source includes a plurality of emitters. The spatial optical modulator includes a modulating part in which a plurality of modulation regions to be irradiated with illumination light derived from light emitted from each of the plurality of light emitters are set. The reflector has a reflective surface that is irradiated with modulated light modulated in each of the plurality of modulation regions and reflects the modulated light modulated in each of the plurality of modulation regions in a certain direction in the horizontal plane. The reflector has a shape in which a first surface of a circular shape having a first radius faces a second surface of a circular shape having a second radius smaller than the first radius. In the reflector, a side surface surrounding peripheral edges of the first surface and the second surface forms a reflective surface, and a through hole penetrating from the first surface to the second surface is formed. The light source is arranged at a position at which an optical path of the illumination light passes through the through hole from the first surface toward the second surface. The spatial optical modulator is arranged at a position at which the second surface of the reflector faces the modulating part, and modulated light obtained by modulating the illumination light emitted from the light source is reflected toward the reflective surface of the reflector. The communication control unit sets a phase image used for spatial optical communication in the modulating part of the spatial optical modulator included in the transmitter, and controls the light source included in the transmitter in such a way that the modulating part is irradiated with light. The modulated light reflected by the reflective surface of the reflector is transmitted as a spatial optical signal (projection light).

The transmission device according to the present example embodiment transmits the spatial optical signal derived from the irradiation light emitted from any one of a plurality of emitters included in the light source in a certain direction in the horizontal plane. Therefore, the transmission device of the present example embodiment can transmit the spatial optical signal with stable intensity to a plurality of communication targets arranged in a certain direction in the horizontal plane. That is, the transmission device of the present example embodiment can consecutively transmit the spatial optical signal for the spatial optical communication to the communication targets arranged in a certain direction in the horizontal plane.

The transmitter according to an aspect of the present example embodiment includes an additional reflector, and the additional reflector has a shape in which a third surface of a circular shape with a third radius equal to or smaller than the second radius faces a fourth surface of a circular shape with a fourth radius smaller than the third surface. The additional reflector includes an additional reflective surface formed on a side surface surrounding peripheral edges of the third surface and the fourth surface and a through hole formed to penetrate from the third surface toward the fourth surface. The third surface of the additional reflector is positioned to overlap the second surface of the reflector. The spatial optical modulator is arranged at a position at which the fourth surface of the additional reflector faces the modulating part, and the modulated light obtained by modulating the illumination light emitted from the light source is reflected toward either the reflective surface or the additional reflective surface. In the present aspect, the reflector is assigned to one of the two communication targets arranged on the substantially same straight line with the transmitter interposed therebetween, and the additional reflector is assigned to the other communication target. As a result, according to the present aspect, it is possible to transmit the spatial optical signal with no ghost image to the two communication targets arranged on the substantially same straight line with the transmitter interposed therebetween.

In an aspect of the present example embodiment, the reflector includes a first reflector and a second reflector. The first reflector has a shape in which a first surface of a semicircular shape having a first radius faces a second surface of a semicircular having a second radius smaller than the first radius. Side surfaces surrounding the peripheral edges of the first surface and the second surface form a reflective surface. The second reflector has a shape in which a third surface of a semicircular shape having a third radius faces a fourth surface of a semicircular shape having a fourth radius smaller than the third radius. Side surfaces surrounding the peripheral edges of the third surface and the fourth surface form a reflective surface. The first reflector and the second reflector are arranged in such a way that diameter portions thereof overlap each other in the planar view and deviate from each other in the vertical direction. The light source is arranged at a position at which an optical path of the illumination light travels from the first surface of the first reflector toward the fourth surface of the second reflector. The spatial optical modulator is arranged at a position at which the fourth surface of the second reflector faces the modulating part, and the modulated light obtained by modulating the illumination light emitted from the light source is reflected toward either the reflective surface of the first reflector or the second reflector. In the present aspect, the first reflector is assigned to one of the two communication targets arranged on the substantially same straight line with the transmitter interposed therebetween, and the second reflector is assigned to the other communication target. As a result, according to the present aspect, it is possible to transmit the spatial optical signal with no ghost image to the two communication targets arranged on the substantially same straight line with the transmitter interposed therebetween.

### Second Example Embodiment

Next, a transmission device according to a second example embodiment will be described with reference to the drawings. The transmission device of the present example embodiment is different from that of the first example embodiment in that a reflecting mirror having a through hole formed therein is arranged between a spatial optical modulator and a reflector. In the present example embodiment, a structure for downsizing the transmission device and giving a degree of freedom to the position of the light source will be described.

### Configuration

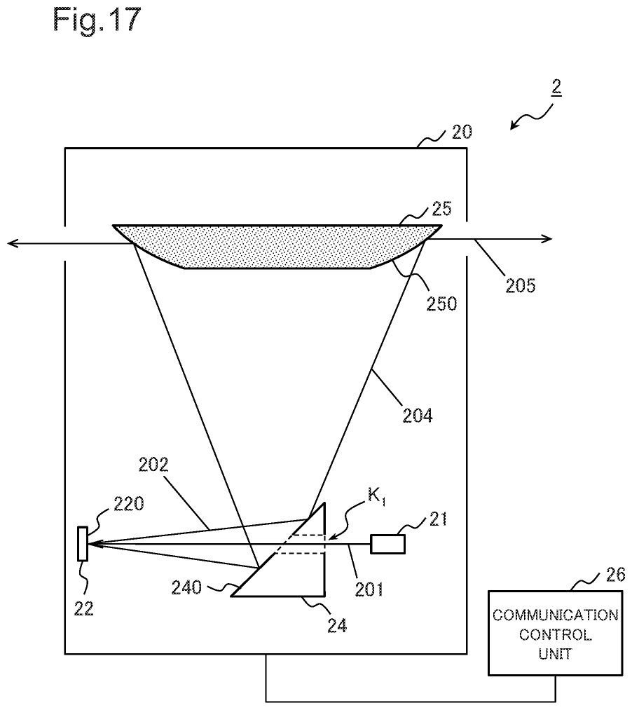

FIG. 17 is a conceptual diagram illustrating an example of a configuration of a transmission device 2 according to the present disclosure. The transmission device 2 includes a transmitter 20 and a communication control unit 26. FIG. 17 is a side view illustrating an internal configuration of the transmitter 20. The transmitter 20 is stored in a housing (not illustrated) in which an opening for transmitting the spatial optical signal is formed. The transmitter 20 includes a light source 21, a spatial optical modulator 22, a relay reflector 24, and a reflector 25. FIG. 17 is a conceptual diagram and not intended to accurately depict a shape of each component, a positional relationship between components, traveling of light, or the like.

The light source 21 has a configuration similar to the light source 11 of the first example embodiment. The light source 21 emits illumination light 201. The emission surface of the light source 21 faces to a modulating part 220 of the spatial optical modulator 22 via a through hole K₁ formed in the relay reflector 24. The illumination light 201 emitted from the light source 21 passes through the through hole K₁ formed in the relay reflector 24 and is irradiated to the modulating part 220 of the spatial optical modulator 22. The light source 21 may be arranged inside the through hole K₁ formed in the relay reflector 24.

The spatial optical modulator 22 has a configuration similar to the spatial optical modulator 12 of the first example embodiment. The spatial optical modulator 22 is a phase modulation-type spatial optical modulator. The spatial optical modulator 22 includes a modulating part 220. A plurality of modulation regions are set in the modulating part 220. A pattern (also referred to as a “phase image”) associated with an image to be displayed by projection light 205 is set in each of the plurality of modulation regions under the control of the communication control unit 26. The illumination light 201 incident on each of the plurality of modulation regions set in the modulating part 220 is modulated in accordance with the pattern (phase image) set in each of the plurality of modulation regions. The modulated light 202 modulated in each of the plurality of modulation regions travels toward a relay reflective surface 240 of the relay reflector 24.

The relay reflector 24 has an outer shape of a right-angle prism. The relay reflective surface 240 is formed on an inclined surface of the relay reflector 24. The inclination angle of the relay reflective surface 240 is 45 degrees. The relay reflector 24 is arranged between the light source 21 and the spatial optical modulator 22. The relay reflector 24 is arranged below the reflector 25. The through hole K₁ is formed in the relay reflector 24. In the example of FIG. 17, the through hole K₁ penetrates the relay reflector 24 in the left-right direction in a plane of a paper surface.

The modulated light 202 modulated in each of the plurality of modulation regions set in the modulating part 220 of the spatial optical modulator 22 travels toward the relay reflective surface 240 of the relay reflector 24. The modulated light 202 reaching the relay reflective surface 240 is reflected by the relay reflective surface 240. Reflected light 204 reflected by the relay reflective surface 240 travels toward the reflective surface of the reflector 25.

The reflector 25 is a reflector having a curved reflective surface 250. The reflector 25 has a circular shape in a planar view. The reflector 25 has a circular upper surface (first surface) having a first radius and a circular lower surface (second surface) having a second radius smaller than the first radius. The center of the circle on the upper surface coincides with the center of the circle on the lower surface. The side surface of the reflector 25 has a smooth curved surface formed from the upper surface toward the lower surface. A side surface (curved surface) of the reflector 25 is the reflective surface 250. That is, the reflector 25 is a reflecting mirror having the curved reflective surface 250.

The reflective surface 250 of the reflector 25 is adjusted to have an angle according to the projection direction of the projection light 205. The reflective surface 250 of the reflector 25 has a curvature according to the projection angle of projection light 205. For example, the curvature of the reflective surface 250 of the reflector 25 is adjusted in such a way that the projection angle of the projection light 205 becomes about 6 degrees. The shape of the reflective surface 250 of the reflector 25 is not limited as long as the curved portion is included. For example, the reflective surface 250 of the reflector 25 may be a free cured surface or a spherical surface. For example, the reflective surface 250 of the reflector 25 may not be a single curved surface but may have a shape in which a plurality of curved surfaces are combined. Furthermore, the reflective surface 250 may be a plane surface. In the case in which the reflective surface 250 is a plane surface, the adjustment range of the projection angle of the projection light 205 is narrower than in the case in which the reflective surface 250 is a curved surface. In the case in which the reflective surface 250 is a plane surface, the projection light 205 reaches a far place because the spread is smaller than in the case in which the reflective surface 250 is a curved surface. For example, the reflective surface 250 of the reflector 25 may have a shape in which a curved surface and a plane surface are combined. Furthermore, a lens (not illustrated) may be arranged at the stage following the reflector 25 in order to limit the spread of the projection light 205.

The reflector 25 is arranged above the relay reflector 24. The reflective surface 250 is irradiated with the reflected light 204 reflected by the relay reflective surface 240 of the relay reflector 24 among the modulated light 202 modulated by the modulating part 220. The reflected light 204 with which the reflective surface 250 is irradiated is reflected by the reflective surface 250. The light (projection light 205) reflected by the reflective surface 250 is enlarged at an enlargement ratio according to the curvature of the reflective surface 250 and projected. The projection light 205 spreads while traveling away from the transmission device 2.

The reflective surface 250 of the reflector 25 is oriented in a certain direction in the horizontal plane. Therefore, the transmission device 2 can control the pattern (phase image) set in the modulating part 220 of the spatial optical modulator 22 in such a way that the projection light 205 is projected in a certain direction in the horizontal plane. Furthermore, the transmission device 2 can associate the plurality of modulation regions M set in the modulating part 220 with different directions and then simultaneously transmit the projection light 205 (spatial optical signals) toward the communication targets arranged in a plurality of directions.

The communication control unit 26 has a configuration similar to the communication control unit 16 of the first example embodiment. The communication control unit 26 controls the light source 21 and the spatial optical modulator 22. The communication control unit 26 sets the phase image associated with the image to be projected in the modulating part 220 in accordance with the aspect ratio of tiling set in the modulating part 220 of the spatial optical modulator 22. The communication control unit 26 sets the phase image associated with the image to be projected in the modulation region set in the modulating part 220 of the spatial optical modulator 22.

The communication control unit 26 drives the light source 21 in a state in which the phase image associated with the image to be displayed is set in the modulating part 220 of the spatial optical modulator 22. As a result, the modulating part 220 is irradiated with the illumination light 201 emitted from the light source 21 in the state in which the phase image is set in the modulating part 220. The illumination light 201 with which the modulating part 220 is irradiated is modulated by the modulating part 220. The modulated light 202 modulated by the modulating part 220 travels toward the reflective surface 250 of the reflector 25.

Furthermore, the communication control unit 26 modulates the illumination light 201 emitted from the light source 21 for communication with the communication target (not illustrated). In communication, the communication control unit 26 controls a timing at which the illumination light 201 is emitted from the light source 21 in a state in which the phase image for communication is set in the modulating part 220 of the spatial optical modulator 22. The illumination light 201 is modulated by this control. The modulation pattern of the illumination light 201 in the communication is arbitrarily set. For example, a configuration for communication (communication unit) may be added in addition to the communication control unit 26. In this case, the communication control unit 26 may be configured to control the light source 21 and the spatial optical modulator 22 in accordance with conditions set by the communication unit.

### Modifications

Next, modifications of the transmission device 2 of the present example embodiment will be described with reference to the drawings. Hereinafter, an example in which a reflector having a plurality of plane mirrors installed to be movable is arranged instead of the reflector 25 will be described. Furthermore, in the following description, a modification for preventing transmission of the spatial optical signal derived from the ghost image of the spatial optical signal and a modification of taking rainfall countermeasures will also be described.

### Fourth Modification

The fourth modification is an example in which a reflector having a plurality of movable plane mirrors is arranged instead of the reflector 25.

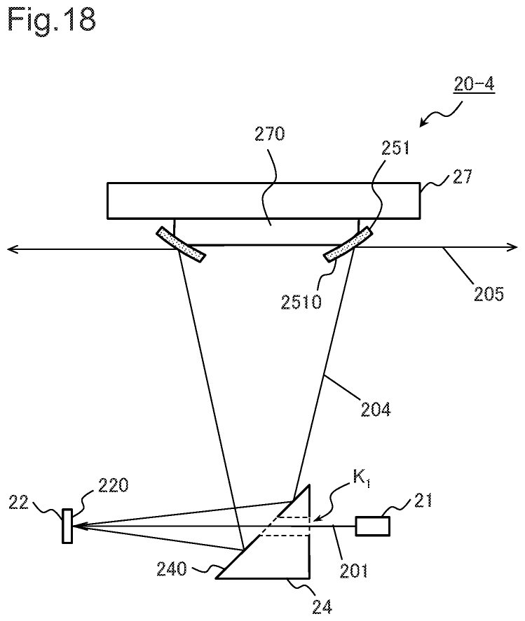

FIG. 18 is a conceptual diagram illustrating an example of a configuration of a transmitter 20-4 according to the fourth modification. FIG. 18 is a diagram illustrating an internal configuration of the transmitter 20-4 viewed from the side. The transmitter 20-4 includes a light source 21, a spatial optical modulator 22, a relay reflector 24, and a reflector 27. The light source 21, the spatial optical modulator 22, and the relay reflector 24 have configurations similar to those illustrated in FIG. 17. Description of the light source 21, the spatial optical modulator 22, and the relay reflector 24 is omitted.

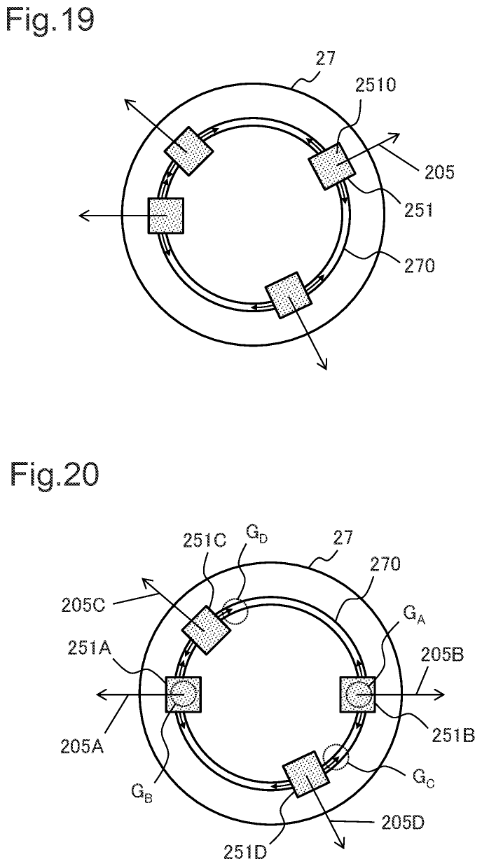

FIG. 19 is a conceptual diagram illustrating the reflector 27 viewed from the bottom. The reflector 27 has a plurality of movable reflectors 251. The reflector 27 has a circular shape in a planar view. A circular track 270 is installed in the reflector 27. A plurality of movable reflectors 251 are movably installed on the circular track 270. The movable reflector 251 has a reflective surface 2510. The reflective surface 2510 is planar in the horizontal direction and has curvature in the vertical direction. The plurality of movable reflectors 251 are movable along the circular track 270. The plurality of movable reflectors 251 move along the circular track 270 under the control of the communication control unit 26. In FIG. 19, the projection direction of the projection light 205 is indicated by an arrow in association with the movable reflector 251.

The reflected light 204 reflected by the relay reflective surface 240 of the relay reflector 24 travels toward the reflective surface 2510 of one of the movable reflectors 251 of the reflector 27. The light (projection light 205) reflected by the reflective surface 2510 of the movable reflector 251 is projected in a direction associated with the position of the reflective surface 2510. According to the present modification, it is possible to move the movable reflector 251 and transmit the spatial optical signal in a certain direction in the horizontal plane.

### Fifth Modification

The fifth modification is an example for causing the spatial optical signal derived from the ghost image not to be transmitted by moving the plane mirror from the position of the ghost image in the configuration of the fourth modification.

FIG. 20 is a conceptual diagram for describing an example of a ghost image that may occur in transmission of the spatial optical signal using the transmitter 20-4 of the fourth modification. FIG. 20 is a bottom view of the reflector 27 viewed from the bottom. FIG. 20 illustrates the position of the ghost image generated when the projection light 205 is projected via the movable reflector 251.

A movable reflector 251A and a movable reflector 251B are used for communication with two communication targets arranged on the substantially same straight line with the transmitter 20-4 interposed therebetween. Therefore, the movable reflector 251A and the movable reflector 251B are in a point-symmetrical positional relationship with respect to a central point of the circular track 270. The position of the movable reflector 251B is irradiated with a ghost light G_{A} which is a ghost image of the irradiation light for forming the projection light 205A projected via the movable reflector 251A. On the other hand, the position of the movable reflector 251A is irradiated with a ghost light G_{B} that is a ghost image of the irradiation light for forming the projection light 205B projected via the movable reflector 251B. Therefore, the ghost light G_{B} interferes with the projection light 205A, and the ghost light G_{A} interferes with the projection light 205B.

The movable reflector 251C and the movable reflector 251D are not used for communication with the two communication targets arranged on the substantially same straight line with the transmitter 20-4 interposed therebetween. Therefore, the movable reflector 251C and the movable reflector 251D are not the movable reflector 251 having the point-symmetrical positional relationship with respect to the central point of the circular track 270. The position of any one of the movable reflectors 251 is not irradiated with a ghost light G_{C} that is a ghost image of the irradiation light for forming the projection light 205C projected via the movable reflector 251C. Similarly, the position of any one of the movable reflectors 251 is not irradiated with a ghost light G_{D} that is a ghost image of the irradiation light for forming the projection light 205D projected via the movable reflector 251D. Therefore, the ghost image does not interfere with the projection light 205C and the projection light 205D.

As in the example of FIG. 20, in the configuration of the fourth modification, in a situation in which communication with the two communication targets arranged on the substantially same straight line with the transmitter 20-4 interposed therebetween is performed, the two movable reflectors 251 have a point-symmetric al positional relationship with respect to the central point of the circular track 270. In this situation, one of the movable reflectors 251 is irradiated with the ghost image of the other movable reflector 251, and the projection light 205 and the ghost image interfere with each other.

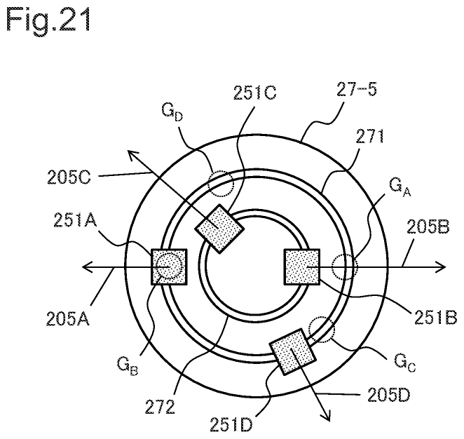

FIG. 21 is a conceptual diagram illustrating an example of a configuration of a reflector 27-5 according to the fifth modification. The reflector 27-5 of the present modification is used instead of the reflector 27 of the fourth modification. FIG. 21 is a conceptual diagram illustrating the reflector 27-5 viewed from the bottom. The reflector 27-5 includes a first circular track 271 and a second circular track 272. The first circular track 271 and the second circular track are concentric tracks having the substantially same center in a planar view. The radius of the first circular track 271 is larger than the radius of the second circular track 272. The reflector 27 has a plurality of movable reflectors 251. The movable reflector 251 includes a planar reflective surface 2510. A movable reflector 251A and a movable reflector 251D are movably installed on the first circular track 271. A movable reflector 251B and a movable reflector 251C are movably installed on the second circular track 272. The plurality of movable reflectors 251 move along the first circular track 271 or the second circular track 272 under the control of the communication control unit 26. In FIG. 21, the projection direction of the projection light 205 is indicated by an arrow in association with the movable reflector 251. FIG. 21 illustrates the position of the ghost image generated when the projection light 205 is projected via the movable reflector 251.

The movable reflector 251A and the movable reflector 251B are used for communication with two communication targets arranged on the substantially same straight line with the transmitter 20 including the reflector 27-5 installed therein interposed therebetween. The movable reflector 251A is arranged on the first circular track 271. The movable reflector 251B is arranged on the second circular track 272. The position of the movable reflector 251B is not irradiated with the ghost light G_{A} which is a ghost image of the irradiation light for forming the projection light 205A projected via the movable reflector 251A. Similarly, the position of the movable reflector 251A is not irradiated with a ghost light G_{B} that is a ghost image of the irradiation light for forming the projection light 205B projected via the movable reflector 251B. Therefore, the ghost light G_{B} and the ghost light G_{A} do not interfere with the projection light 205A and the projection light 205B.

The movable reflector 251C and the movable reflector 251D are not used for communication with the two communication targets arranged on the substantially same straight line with the transmitter 20 including the reflector 27-5 installed therein interposed therebetween. The position of any one of the movable reflectors 251 is not irradiated with a ghost light G_{C} that is a ghost image of the irradiation light for forming the projection light 205C projected via the movable reflector 251C. Similarly, the position of any one of the movable reflectors 251 is not irradiated with a ghost light G_{D} that is a ghost image of the irradiation light for forming the projection light 205D projected via the movable reflector 251D. Therefore, the ghost image does not interfere with the projection light 205C and the projection light 205D.

In the configuration of the fifth modification, even in a situation in which communication with the two communication targets arranged on the substantially same straight line with the transmitter 20 interposed therebetween is performed, it is possible to prevent the two movable reflectors 251 from having the point-symmetric positional relationship with respect to the central points of the first circular track 271 and the second circular track 272. Therefore, one movable reflector 251 is not irradiated with the ghost image of the other movable reflector 251, and the projection light 205 and the ghost image do not interfere with each other.

### Sixth Modification

The sixth modification is an example in which a plurality of spatial optical signals are transmitted in the substantially same direction. In the present modification, a configuration for preventing communication from being interrupted due to an influence of rainfall or the like by multiplexing spatial optical signals will be described. Hereinafter, an example of duplicating the spatial optical signals will be described. The following technique can also be applied to an application in which the spatial optical signals are multiplexed by triple or more multiplexing schemes.

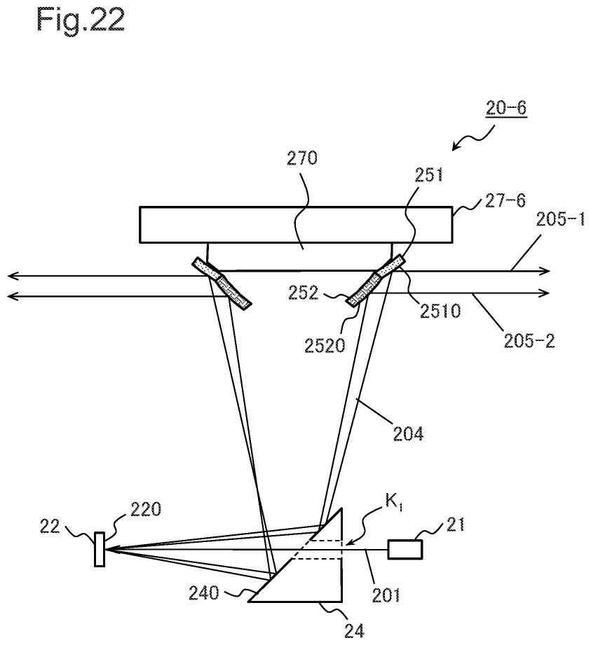

FIG. 22 is a conceptual diagram illustrating an example of a configuration of a transmitter 20-6 according to the sixth modification. FIG. 22 is a diagram illustrating an internal configuration of the transmitter 20-6 viewed from the side. The transmitter 20-6 includes a light source 21, a spatial optical modulator 22, a relay reflector 24, and a reflector 27-6. The light source 21, the spatial optical modulator 22, and the relay reflector 24 have configurations similar to those illustrated in FIG. 17. Description of the light source 21, the spatial optical modulator 22, and the relay reflector 24 is omitted.

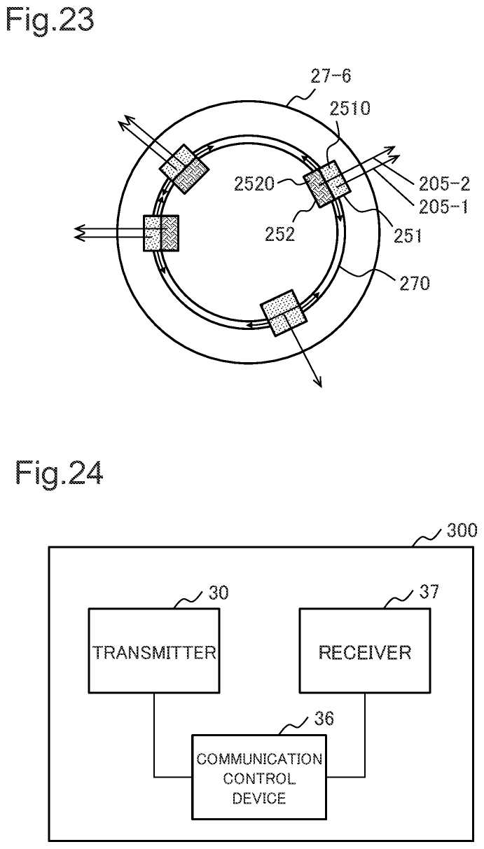

FIG. 23 is a conceptual diagram illustrating the reflector 27 viewed from the bottom. The reflector 27-6 includes a plurality of movable reflectors 251 and a plurality of movable reflectors 252. The movable reflector 251 is combined with any one of the movable reflectors 252 to constitute a reflecting unit. The reflector 27-6 has a circular shape in a planar view: A circular track 270 is installed in the reflector 27-6. A plurality of movable reflectors 251 and a plurality of movable reflectors 252 are movably installed on the circular track 270. The movable reflector 251 includes a planar reflective surface 2510. The movable reflector 252 includes a planar reflective surface 2520. The plurality of movable reflectors 251 and the plurality of movable reflectors 252 are movable along the circular track 270. The plurality of movable reflectors 251 and the plurality of movable reflectors 252 move along the circular track 270 under the control of the communication control unit 26. In FIG. 23, the projection direction of the projection light 205-1 associated with the movable reflector 251 and the projection direction of the projection light 205-2 associated with the movable reflector 252 are indicated by arrows.

The reflected light 204 reflected by the relay reflective surface 240 of the relay reflector 24 travels toward any one reflecting unit installed in the reflector 27-6. The light (projection light 205-1) reflected by the reflective surface 2510 of the movable reflector 251 is projected in a direction associated with the position of the reflective surface 2510. The light (projection light 205-2) reflected by the reflective surface 2520 of the movable reflector 252 is projected in a direction associated with the position of the reflective surface 2520. Projection light 205 reflected by the movable reflector 251 and the movable reflector 252 constituting the same reflecting unit is multiplexed by projection light 205-1 and projection light 205-2. According to the present modification, it is possible to transmit the multiplexed spatial optical signal in all directions along the horizontal plane by moving the reflection unit including the movable reflector 251 and the movable reflector 252.

As described above, the transmission device of the present example embodiment includes the transmitter and the communication control unit. The transmitter includes a light source, a spatial optical modulator, a relay reflector, and a reflector. The light source includes a plurality of emitters. The spatial optical modulator includes a modulating part in which a plurality of modulation regions to be irradiated with illumination light derived from light emitted from each of the plurality of light emitters are set. The relay reflector is arranged between the light source and the spatial optical modulator. The relay reflector has an outer shape of a right-angle prism in which a relay reflective surface is formed on an inclined surface and a through hole formed to penetrate the relay reflective surface. The reflector has a reflective surface that is irradiated with modulated light modulated in each of the plurality of modulation regions and reflects the modulated light modulated in each of the plurality of modulation regions in a certain direction in the horizontal plane. The reflector has a shape in which a first surface of a circular shape having a first radius faces a second surface of a circular shape having a second radius smaller than the first radius. In the reflector, a side surface surrounding peripheral edges of the first surface and the second surface forms a reflective surface, and a through hole penetrating from the first surface to the second surface is formed. The light source is arranged at a position through which the illumination light passes toward the relay reflective surface via the through hole of the relay reflector. The spatial optical modulator is arranged at a position at which the relay reflective surface of the relay reflector faces the modulating part, and the modulated light obtained by modulating the illumination light emitted from the light source is reflected toward the relay reflective surface. The relay reflector is arranged at a position at which the modulated light modulated by the modulating part of the spatial optical modulator is reflected toward the reflective surface. The communication control unit sets a phase image used for spatial optical communication in the modulating part of the spatial optical modulator included in the transmitter, and controls the light source included in the transmitter in such a way that the modulating part is irradiated with light. The modulated light reflected by the reflective surface of the reflector is transmitted as a spatial optical signal (projection light).

The transmission device according to the present example embodiment transmits the spatial optical signal derived from the irradiation light emitted from any one of a plurality of emitters included in the light source in a certain direction in the horizontal plane. Therefore, the transmission device of the present example embodiment can transmit the spatial optical signal with stable intensity to a plurality of communication targets arranged in a certain direction in the horizontal plane. That is, the transmission device of the present example embodiment can consecutively transmit the spatial optical signal for the spatial optical communication to the communication targets arranged in a certain direction in the horizontal plane. Furthermore, in the transmitter of the present example embodiment, since the optical paths of the illumination light and the modulated light are bent using the relay reflector, the height in the vertical direction can be reduced as compared with the first example embodiment. In addition, according to the present example embodiment, the distance between the spatial optical modulator and the reflector can be increased as compared with the first example embodiment. Therefore, according to the present example embodiment, since the curvature of the reflective surface of the reflector is reduced by increasing the diameter of the reflector, the spatial optical signal can be transmitted farther.

In an aspect of the present example embodiment, the reflector includes the circular track and a plurality of movable reflectors movably arranged on the circular track. The relay reflector is arranged at a position at which the modulated light modulated by the modulating part is reflected toward the circular track. According to the present aspect, as the movable reflector is moved in accordance with the position of the communication target, the spatial optical signal for the spatial optical communication can be consecutively transmitted toward the communication target arranged in a certain direction in the horizontal plane.

In an aspect of the present example embodiment, the circular track is configured with a first circular track and a second circular track arranged concentrically. The plurality of movable reflectors are movably arranged on either the first circular track or the second circular track. According to the present aspect, the movable reflector arranged on the first circular track is allocated to one of the two communication targets arranged on the substantially same straight line with the transmitter interposed therebetween, and the movable reflector arranged on the second circular track is allocated to the other communication target. As a result, according to the present aspect, it is possible to transmit the spatial optical signal with no ghost image to the two communication targets arranged on the substantially same straight line with the transmitter interposed therebetween.

### Third Example Embodiment

Next, a communication device according to a third example embodiment will be described with reference to the drawings. The communication device of the present example embodiment has a configuration in which a reception device is combined with a transmission device. The transmission device has a configuration similar to that of any one of the first to second example embodiments. The reception device is not particularly limited as long as it can receive the spatial optical signal. Hereinafter, an example of the reception device with a light receiving function including a ball lens will be described. The communication device of the present example embodiment may include a reception device having other light receiving functions instead of the light receiving function including the ball lens.

FIG. 24 is a conceptual diagram illustrating an example of a configuration of a communication device 300 according to the present disclosure. The communication device 300 includes a transmitter 30, a communication control device 36, and a receiver 37. The communication device 300 transmits and receives the spatial optical signals to and from the external communication targets. Therefore, an opening or a window for transmitting and receiving the spatial optical signal is formed in the communication device 300.

The transmitter 30 is any one of the transmission devices of the first and second example embodiments. The transmitter 30 acquires a control signal from the communication control device 36. The transmitter 30 projects the spatial optical signal associated with the control signal. The spatial optical signal projected from the transmitter 30 is received by a communication target (not illustrated) of a transmission destination of the spatial optical signal.

The communication control device 36 acquires the signal output from the receiver 37. The communication control device 36 executes processing according to the acquired signal. The processing executed by the communication control device 36 is not particularly limited. The communication control device 36 outputs a control signal for transmitting an optical signal obtained by the executed processing to the transmitter 30. For example, the communication control device 36 executes processing based on a predetermined condition in accordance with information included in a signal received by the receiver 37. For example, the communication control device 36 executes processing designated by the administrator of the communication device 300 in accordance with information included in the signal received by the receiver 37.

The receiver 37 receives the spatial optical signal transmitted from the communication target (not illustrated). The receiver 37 converts the received spatial optical signal into an electrical signal. The receiver 37 outputs the converted electric signal to the communication control device 36. For example, the receiver 37 has a light receiving function including a ball lens. Furthermore, the receiver 37 may have a light receiving function that does not include a ball lens.

### [Reception Device]

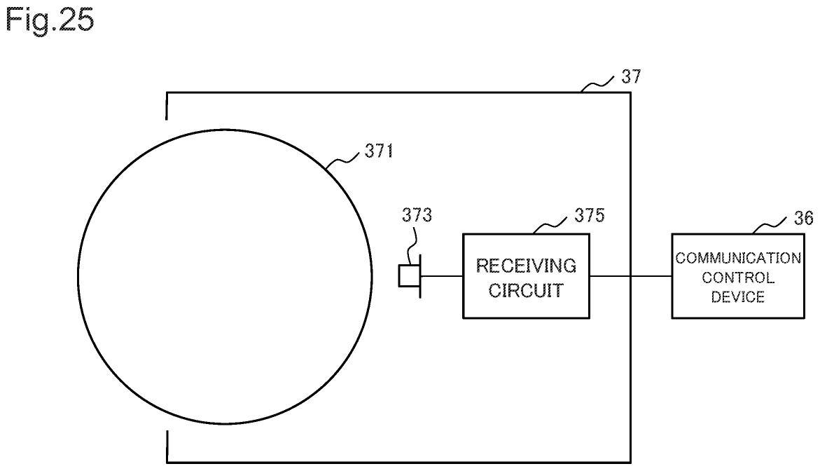

Next, a configuration of the receiver 37 will be described with reference to the drawings. FIG. 25 is a conceptual diagram for describing an example of a configuration of the receiver 37. The receiver 37 includes a ball lens 371, a light receiving element 373, and a receiving circuit 375. FIG. 25 is a side view illustrating an internal configuration of the receiver 37 viewed from the side. The position of the receiving circuit 375 is not particularly limited. The receiving circuit 375 may be arranged inside the receiver 37 or may be arranged outside the receiver 37. Furthermore, the function of the receiving circuit 375 may be included in the communication control device 36.

The ball lens 371 is a spherical lens. The ball lens 371 is an optical element that condenses the spatial optical signal transmitted from the communication target. The ball lens 371 has a spherical shape when viewed at a certain angle. A part of the ball lens 371 protrudes from an opening formed in a housing of the receiver 37. The ball lens 371 condenses the incident spatial optical signal. The spatial optical signal incident on the ball lens 371 protruding from the opening is condensed. A part of the ball lens 371 may not protrude from the opening as long as the spatial optical signal can be condensed.

The light (optical signal) derived from the spatial optical signal condensed by the ball lens 371 is condensed toward a condensing region of the ball lens 371. Since the ball lens 371 has a spherical shape, the ball lens condenses the spatial optical signal arriving in a certain direction. That is, the ball lens 371 exhibits similar light condensing performance for the spatial optical signal arriving in a certain direction. The light incident on the ball lens 371 is refracted when entering the inside of the ball lens 371. Furthermore, the light traveling inside the ball lens 371 is refracted again when being emitted to the outside of the ball lens 371. Most of the light emitted from the ball lens 371 is condensed in the condensing region.

For example, the ball lens 371 can be made of a material such as glass, crystal, or resin. In the case of receiving the spatial optical signal of the visible region, the ball lens 371 can be implemented by a material such as glass, crystal, or resin that transmits/refracts light of the visible region. For example, the ball lens 371 can be implemented by optical glass such as crown glass or flint glass. For example, the ball lens 371 can be implemented by crown glass such as Boron Kron (BK). For example, the ball lens 371 can be implemented by a flint glass such as Lanthanum Schwerflint (LaSF). For example, quartz glass can be applied to the ball lens 371. For example, crystal such as sapphire can be applied to the ball lens 371. For example, a transparent resin such as acrylic can be applied to the ball lens 371.

In a case in which the spatial optical signal is light of a near infrared region (hereinafter, “near infrared rays”), a material that transmits near infrared rays is used for the ball lens 371. For example, in the case of receiving the spatial optical signal of the near-infrared region of about 1.5 micrometers (μm), a material such as silicon can be applied to the ball lens 371 in addition to glass, crystal, resin, and the like. In a case in which the spatial optical signal is light of an infrared region (Hereinafter, “infrared rays”), a material that transmits infrared rays is used for the ball lens 371. For example, in a case in which the spatial optical signal is an infrared ray, a material based on silicon, germanium, or chalcogenide can be applied to the ball lens 371. The material of the ball lens 371 is not limited as long as the light of the wavelength region of the spatial optical signal can be transmitted/refracted. The material of the ball lens 371 may be appropriately selected in accordance with a required refractive index or purpose.

The ball lens 371 may be replaced with another concentrator as long as the spatial optical signal can be condensed toward the region in which the light receiving element 373 is arranged. For example, the ball lens 371 may be a light beam control element that guides the incident spatial optical signal toward the light receiving unit of the light receiving element 373. For example, the ball lens 371 may have a configuration in which a lens or a light beam control element is combined. For example, a mechanism that guides the optical signal condensed by the ball lens 371 toward the light receiving unit of the light receiving element 373 may be added.

The light receiving element 373 is arranged at the stage following the ball lens 371. The light receiving element 373 is arranged in the condensing region of the ball lens 371. The light receiving element 373 includes a light receiving unit that receives the optical signal condensed by the ball lens 371. The optical signal condensed by the ball lens 371 is received by the light receiving unit of the light receiving element 373. The light receiving element 373 converts the received optical signal into an electric signal (hereinafter, a “signal”). The light receiving element 373 outputs the converted signal to the receiving circuit 375. FIG. 25 illustrates an example in which the light receiving element 373 is a single element. For example, a plurality of light receiving elements 373 may be arranged in the condensing region of the ball lens 371. For example, a light receiving element array in which a plurality of light receiving elements 373 are arrayed may be arranged in the condensing region of the ball lens 371.

The light receiving element 373 receives the light of the wavelength region of the spatial optical signal to be received. For example, the light receiving element 373 has sensitivity to the light of the visible region. For example, the light receiving element 373 has sensitivity to the light of the infrared region. For example, the light receiving element 373 has sensitivity to the light of the wavelength of a 1.5 μm (micrometer) band. The wavelength band of the light to which the light receiving element 373 has sensitivity is not limited to the 1.5 μm band. The wavelength band of the light received by the light receiving element 373 can be arbitrarily set in accordance with the wavelength of the spatial optical signal to be received. The wavelength band of the light received by the light receiving element 373 may be set to, for example, a 0.8 μm band, a 1.55 μm band, or a 2.2 μm band. Furthermore, the wavelength band of the light received by the light receiving element 373 may be, for example, a 0.8 to 1 μm band. A shorter wavelength band is advantageous for spatial optical communication during rainfall because absorption by moisture in the atmosphere is small. Furthermore, if the light receiving element 373 is saturated with intense sunlight, it is difficult for the light receiving element to read the optical signal derived from the spatial optical signal. Therefore, a color filter that selectively passes the light of the wavelength band of the spatial optical signal may be installed at the stage preceding the light receiving element 373.

For example, the light receiving element 373 can be implemented by an element such as a photodiode or a phototransistor. For example, the light receiving element 373 is implemented by an avalanche photodiode. The light receiving element 373 implemented by the avalanche photodiode can support high-speed communication. The light receiving element 373 may be implemented by an element other than a photodiode, a phototransistor, or an avalanche photodiode as long as an optical signal can be converted into an electric signal. In order to improve the communication speed, the light receiving unit of the light receiving element 373 is preferably as small as possible. For example, the light receiving unit of the light receiving element 373 has a square light receiving surface having each side of about 5 mm. For example, the light receiving unit of the light receiving element 373 has a circular light receiving surface having a diameter of about 0.1 mm to 0.3 mm. The size or the shape of the light receiving unit of the light receiving element 373 may be selected in accordance with the wavelength band, the communication speed, or the like of the spatial optical signal.

For example, a polarizing filter (not illustrated) may be arranged at the stage preceding the light receiving element 373. The polarizing filter is arranged in association with the light receiving unit of the light receiving element 373. For example, the polarizing filter is arranged to overlap the light receiving unit of the light receiving element 373. For example, the polarization filter may be selected in accordance with the polarization state of the spatial optical signal to be received. For example, when the spatial optical signal to be received is linearly polarized light, the polarizing filter includes a ½ wave plate. For example, when the spatial optical signal to be received is circularly polarized light, the polarizing filter includes a ¼ wave plate. The polarization state of the optical signal having passed through the polarizing filter is converted in accordance with the polarization characteristics of the polarizing filter.

The receiving circuit 375 acquires the signal output from the light receiving element 373. The receiving circuit 375 amplifies the signal output from the light receiving element 373. The receiving circuit 375 decodes the amplified signal. The signal decoded by the receiving circuit 375 is used for a certain purpose. The purpose of the signal decoded by the receiving circuit 375 is not particularly limited.

### [Communication Device]

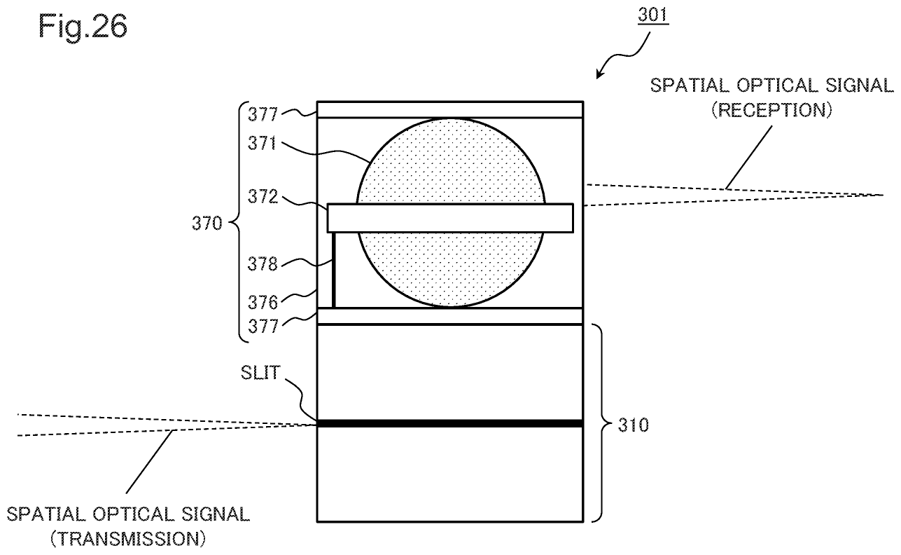

FIG. 26 is a conceptual diagram illustrating an example (communication device 301) of the communication device 300. The communication device 301 includes a transmitter 310, a receiver 370, and a communication control device (not illustrated). In FIG. 26, the receiving circuit and the communication control device are not illustrated. The receiving circuit and the communication control device are arranged inside the communication device 301. The communication device 301 has a configuration in which the transmitter 310 and the receiver 370 having a cylindrical outer shape are combined.

The receiver 370 includes a ball lens 371, a light receiver 372, a color filter 376, and a support element 377. The upper and lower sides of the ball lens 371 are sandwiched between a pair of support elements 377 arranged vertically. Since the upper and lower sides of the ball lens 371 are not used for transmission and reception of the spatial optical signals, the upper and lower sides of the ball lens 371 may be processed to have a planar shape to be easily sandwiched by the support elements 377. The light receiver 372 is arranged to be able to receive the spatial optical signal to be received in accordance with the condensing region of the ball lens 371. The light receiver 372 includes a light receiving element array in which a plurality of light receiving elements are annularly arranged. The plurality of light receiving elements are arranged in the condensing region of the ball lens 371. The plurality of light receiving elements are arranged in such a way that the light receiving unit faces the ball lens 371. The plurality of light receiving elements are connected to a control device (not illustrated) or the transmitter 310 via the conductive wire 378.

The color filter 376 is arranged on a side surface of the cylindrical receiver 370. The color filter 376 removes unnecessary light and selectively transmits a spatial optical signal used for communication. A pair of support elements 377 are arranged on the upper and lower surfaces of the cylindrical receiver 370. The pair of support elements 377 sandwich the upper and lower sides of the ball lens 371. The light receiver 372 formed in an annular shape is arranged around the ball lens 371. The light receiver 372 includes a plurality of light receiving elements in which the light receiving unit faces the ball lens 371. The spatial optical signal incident on the ball lens 371 through the color filter 376 is condensed toward the light receiver 372 by the ball lens 371. The optical signal condensed on the light receiver 372 is guided toward the light receiving unit of one of the light receiving elements. The light signal reaching the light receiving unit of the light receiving element is received by the light receiving element. The communication control device (not illustrated) decodes the optical signal received by the light receiving element included in the light receiver 372. The communication control device causes the transmitter 310 to transmit the spatial optical signal in accordance with the decoded optical signal.

The transmitter 310 is configured by any one of the transmission devices of the first and second example embodiments. The transmitter 310 is housed inside a cylindrical housing. A slit opened in accordance with the transmission direction of the spatial optical signal by the transmitter 310 is formed in the cylindrical housing. For example, in a case in which the transmitter 310 can transmit the spatial optical signal in the direction of 360 degrees, the slit is formed on the side surface of the housing of the transmitter 310 in accordance with the transmission direction of the spatial optical signal.

### Application Example

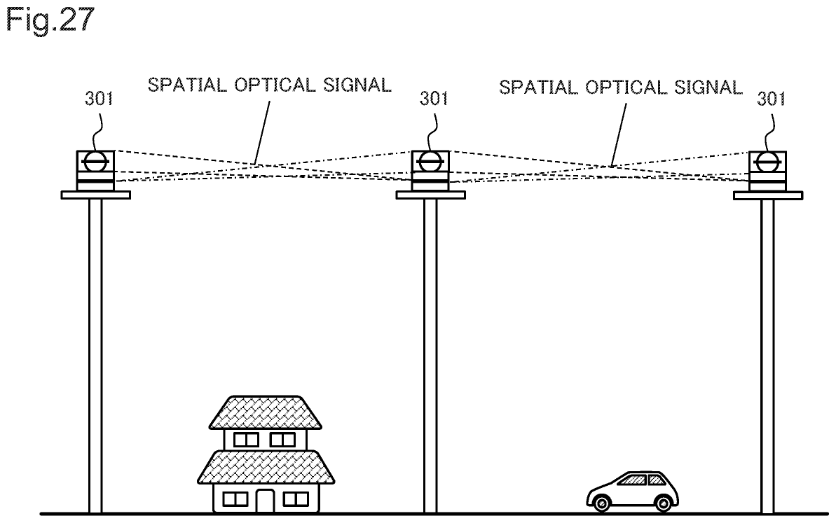

Next, an application example of the present example embodiment will be described with reference to the drawings. In the following application example, an example in which a plurality of communication devices 301 transmit and receive the spatial optical signals will be described. FIG. 27 is a conceptual diagram for describing the present application example. In the present application example, an example (communication system) of a communication network in which a plurality of communication devices 301 are arranged on an upper portion (space above a pole) of a pole such as a utility pole or a street lamp arranged in a town will be described.

There are few obstacles in the space above the pole. Therefore, the space above the pole is suitable for installation of the communication device 301. Furthermore, in a case in which the communication device 301 is installed at the substantially same height, the arrival direction of the spatial optical signal is limited to the horizontal direction. Therefore, the light reception area of the light receiver constituting the receiver 370 can be reduced, and the device can be more simplified. The pair of communication devices 301 that transmit and receive the spatial optical signal are arranged in such a way that at least one communication device 301 receives the spatial optical signal transmitted from the other communication device 301. The pair of communication devices 301 may be arranged to transmit and receive the spatial optical signals to and from each other. In a case in which the communication network of the spatial optical signal is configured with a plurality of communication devices 301, the communication devices 301 positioned in the middle may be arranged to relay the spatial optical signals transmitted from the other communication devices 301 to another communication apparatus 301.

According to the present application example, the communication using a spatial optical signal can be performed among the plurality of communication devices 301 arranged in the space above the pole. For example, communication by wireless communication may be performed between wireless devices or base stations installed in an automobile, a house, or the like and the communication device 301 in accordance with the communication between the communication devices 301. For example, the communication device 301 may be connected to the Internet via a communication cable or the like installed on a pole.

As described above, the communication device according to the present example embodiment includes the reception device, the transmission device, and the communication control device. The transmission device is any one of the transmission devices according to the first and second example embodiments. The reception device receives the spatial optical signal from another communication device. The communication control device acquires the signal based on the spatial optical signal received from another communication device by the reception device. The communication control device executes processing associated with the acquired signal. The communication control device causes the transmission device to transmit the spatial optical signal obtained by the executed processing.

The transmission device included in the communication device according to the present example embodiment transmits the spatial optical signal derived from the irradiation light emitted from any one of a plurality of emitters included in the light source in a certain direction in the horizontal plane. Therefore, the transmission device of the present example embodiment can transmit the spatial optical signal with stable intensity to a plurality of communication targets arranged in a certain direction in the horizontal plane. That is, according to the present example embodiment, the spatial optical signal for spatial optical communication can be consecutively transmitted to the communication targets arranged in a certain direction in the horizontal plane.

The communication system according to an aspect of the present example embodiment includes the plurality of communication devices described above. In the communication system, the plurality of communication devices are arranged to transmit and receive the spatial optical signals to and from each other. According to the present aspect, it is possible to implement the communication network that transmits and receives the spatial optical signals.

### Fourth Example Embodiment

Next, a transmitter according to a fourth example embodiment will be described with reference to the drawings. The transmitter of the present example embodiment has a configuration in which the transmitter included in the transmission device of one of the first and second example embodiments is simplified. Hereinafter, the transmitter of the present example embodiment will be described based on the configuration of the transmitter included in the transmission device according to the first example embodiment.

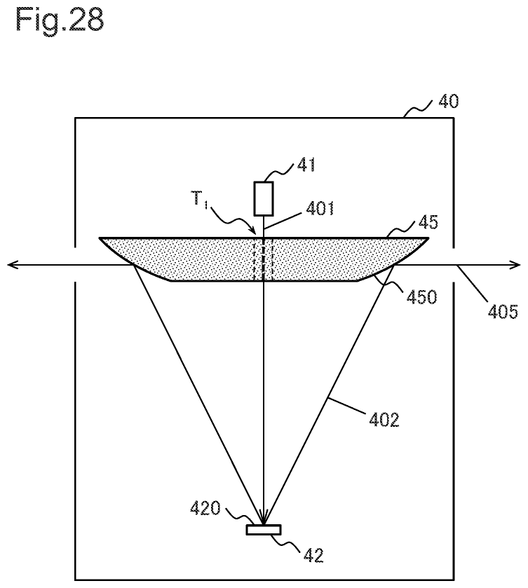

FIG. 28 is a conceptual diagram illustrating an example of a configuration of a transmitter 40 according to the present example embodiment. The transmitter 40 includes a light source 41, a spatial optical modulator 42, and a reflector 45. The light source 41 includes a plurality of light emitters. The spatial optical modulator 42 includes a modulating part 420 in which a plurality of modulation regions to be irradiated with illumination light 401 derived from light emitted from each of the plurality of light emitters are set. The reflector 45 has a reflective surface 450 that is irradiated with modulated light 402 modulated in each of the plurality of modulation regions and reflects the modulated light 402 modulated in each of the plurality of modulation regions toward a certain direction in the horizontal plane. The modulated light 402 reflected by the reflective surface 450 is transmitted as the spatial optical signal (projection light 405).

The transmitter according to the present example embodiment transmits the spatial optical signal derived from the irradiation light emitted from any one of a plurality of emitters included in the light source in a certain direction along the horizontal plane. Therefore, the transmitter of the present example embodiment can transmit the spatial optical signal with stable intensity to a plurality of communication targets arranged in a certain direction in the horizontal plane. That is, the transmitter according to the present example embodiment can consecutively transmit the spatial optical signal for spatial optical communication to the communication targets arranged in a certain direction in the horizontal plane.

### (Hardware)

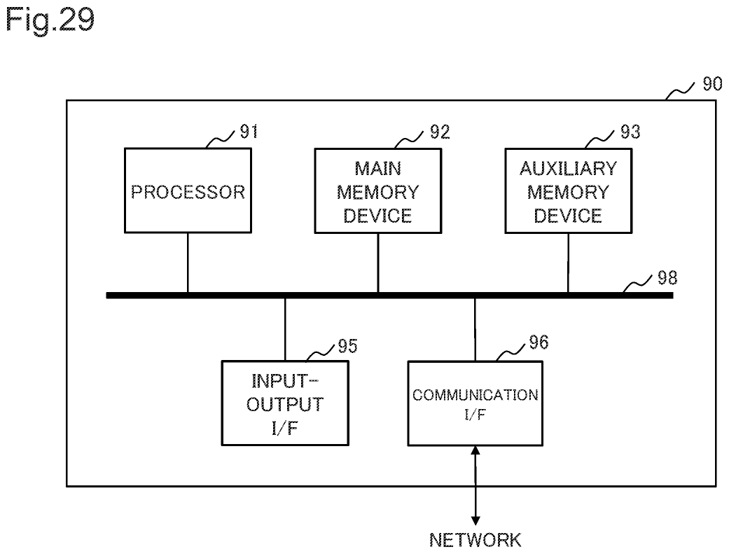

Next, a hardware configuration for executing control or processes according to the present disclosure will be described with reference to the drawings. Here, an information processing device 90 (computer) of FIG. 29 will be described as an example of the hardware configuration. The information processing device 90 on FIG. 29 is a configuration example for executing control or processes of the present disclosure and not intended to limit the scope of the present disclosure.

As illustrated in FIG. 29, the information processing device 90 includes a processor 91, a main memory device 92, an auxiliary memory device 93, an input-output interface 95, and a communication interface 96. In FIG. 29, the interface is abbreviated as I/F. The processor 91, the main memory device 92, the auxiliary memory device 93, the input-output interface 95, and the communication interface 96 are connected to one another via a bus 98 so that data communication can be performed. The processor 91, the main memory device 92, the auxiliary memory device 93, and the input-output interface 95 are connected to a network such as the Internet or an intranet via the communication interface 96.

The processor 91 causes a program (instruction) stored in the auxiliary memory device 93 or the like to be developed in the main memory device 92. For example, the program is a software program for executing control or processes of the present disclosure. The processor 91 executes the program developed in the main memory device 92. The processor 91 executes the program in such a way that control or processes according to the present disclosure is executed.

The main memory device 92 has an area in which a program is developed. A program stored in the auxiliary memory device 93 or the like is developed in the main memory device 92 by the processor 91. The main memory device 92 is implemented by, for example, a volatile memory such as a dynamic random access memory (DRAM). A non-volatile memory such as a magneto resistive random access memory (MRAM) may be configured/added as the main memory device 92.

The auxiliary memory device 93 stores various pieces of data such as programs. The auxiliary memory device 93 is implemented by a local disk such as a hard disk or a flash memory. In a case in which various pieces of data are stored in the main memory device 92, the auxiliary memory device 93 may be omitted.

The input-output interface 95 is an interface for connecting the information processing device 90 with a peripheral device based on a standard or a specification. The communication interface 96 is an interface for connecting to an external system or device via a network such as the Internet or an intranet based on a standard or a specification. The input-output interface 95 and the communication interface 96 may be combined as an interface connected to an external device.

Input devices such as a keyboard, a mouse, and a touch panel may be connected to the information processing device 90 as necessary. These input devices are used to input information or settings. In a case in which a touch panel is used as the input device, a screen having a touch panel function serves as an interface. The processor 91 and the input devices are connected to each other via the input-output interface 95.

The information processing device 90 may be provided with a display device for displaying information. In a case in which the display device is provided, the information processing device 90 includes a display control device (not illustrated) for controlling display of the display device. The information processing device 90 and the display device are connected to each other via the input-output interface 95.

The information processing device 90 may be provided with a drive device. The drive device mediates reading of data or a program stored in a recording medium or writing of a processing result of the information processing device 90 in the recording medium between the processor 91 and the recording medium (program recording medium). The information processing device 90 and the drive device are connected to each other via an input-output interface 95.

The example of the hardware configuration for enabling control or processes according to the present disclosure has been described above. The hardware configuration of FIG. 29 is an example of the hardware configuration for executing control or processes according to the present disclosure and not intended to limit the scope of the present disclosure. A program for causing a computer to execute control or processes according to the present disclosure is also included in the scope of the present disclosure.

A program recording medium in which the program according to the present disclosure is recorded is also included in the scope of the present disclosure. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. Furthermore, the recording medium may be implemented by a magnetic recording medium such as a flexible disk or other recording media. In a case in which the program executed by the processor is recorded in the recording medium, the recording medium is substantially equivalent to the program recording medium.

The components of the present disclosure may be arbitrarily combined. The components of the present disclosure may be implemented by software. The components of the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source including a plurality of emitters;
a spatial optical modulator including a modulating part in which a plurality of modulation regions to be irradiated with illumination light derived from light emitted from each of the plurality of emitters are set; and
a reflector having a reflective surface that is irradiated with modulated light modulated in each of the plurality of modulation regions and reflects the modulated light modulated in each of the plurality of modulation regions in a certain direction in a horizontal plane.

2. The transmitter according to claim 1, wherein
the reflector has a shape in which a first surface of a circular shape with a first radius faces a second surface of a circular shape with a second radius smaller than the first radius, a side surface surrounding peripheral edges of the first surface and the second surface forms a reflective surface, and a through hole penetrating from the first surface to the second surface is formed,
the light source is arranged at a position at which an optical path of the illumination light passes through the through hole of the reflector from the first surface toward the second surface, and
the spatial optical modulator is arranged at a position at which the second surface of the reflector faces the modulating part, and the modulated light obtained by modulating the illumination light emitted from the light source is reflected toward the reflective surface of the reflector.

3. The transmitter according to claim 2, further comprising
an additional reflector having a shape in which a third surface of a circular shape with a third radius equal to or smaller than the second radius faces a fourth surface of a circular shape with a fourth radius smaller than the third surface and including an additional reflective surface formed on a side surface surrounding peripheral edges of the third surface and the fourth surface and a through hole formed to penetrate from the third surface to the fourth surface, the third surface being positioned to overlap the second surface of the reflector, wherein
the spatial optical modulator is arranged at a position at which the fourth surface of the additional reflector faces the modulating part, and the modulated light obtained by modulating the illumination light emitted from the light source is reflected toward either the reflective surface or the additional reflective surface.

4. The transmitter according to claim 1, wherein
the reflector includes
a first reflector having a shape in which a first surface of a semicircular shape with a first radius faces a second surface of a semicircular shape with a second radius smaller than the first radius and including a side surface surrounding peripheral edges of the first surface and the second surface, the side surface forming a reflective surface, and
a second reflector having a shape in which a third surface of a semicircular shape with a third radius faces a fourth surface of a semicircular shape with a fourth radius smaller than the third radius and including a side surface surrounding peripheral edges of the third surface and the fourth surface, the side surface forming a reflective surface,
the first reflector and the second reflector are arranged in such a way that diameter portions overlap each other in a planar view and deviate from each other in a vertical direction,
the light source is arranged at a position at which an optical path of the illumination light extends from the first surface of the first reflector toward the fourth surface of the second reflector, and
the spatial optical modulator is arranged at a position at which the fourth surface of the second reflector faces the modulating part, and the modulated light obtained by modulating the illumination light emitted from the light source is reflected toward any one of the reflective surfaces of the first reflector and the second reflector.

5. The transmitter according to claim 2, further comprising:
a relay reflector arranged between the light source and the spatial optical modulator, having an outer shape of a right-angle prism having a relay reflective surface on an inclined surface, and including a through hole formed to penetrate the relay reflective surface, wherein
the light source is arranged at a position at which the illumination light passes toward the relay reflective surface via the through hole of the relay reflector,
the spatial optical modulator is arranged at a position at which the relay reflective surface of the relay reflector faces the modulating part, and the modulated light obtained by modulating the illumination light emitted from the light source is reflected toward the relay reflective surface, and
the relay reflector is arranged at a position at which the modulated light modulated by the modulating part of the spatial optical modulator is reflected toward the reflective surface.

6. The transmitter according to claim 2, further comprising:
a relay reflector arranged between the light source and the spatial optical modulator, having an outer shape of a right-angle prism having a relay reflective surface on an inclined surface, and including a through hole formed to penetrate the relay reflective surface, wherein
the reflector includes a circular track and a plurality of movable reflectors movably arranged on the circular track,
the light source is arranged at a position at which the illumination light passes toward the relay reflective surface via the through hole of the relay reflector,
the spatial optical modulator is arranged at a position at which the relay reflective surface of the relay reflector faces the modulating part, and the modulated light obtained by modulating the illumination light emitted from the light source is reflected toward the relay reflective surface, and
the relay reflector is arranged at a position at which the modulated light modulated by the modulating part is reflected toward the circular track.

7. The transmitter according to claim 6, wherein
the circular track includes a first circular track and a second circular track arranged concentrically, and
the plurality of movable reflectors are arranged to be movable on any one of the first circular track and the second circular track.

8. A transmission device comprising:
the transmitter according to claim 1; and
a communication controller comprising
a first memory storing instructions, and
a first processor connected to the first memory and configured to execute the instructions to
set a phase image used for spatial optical communication in the modulating part of the spatial optical modulator included in the transmitter, and
control the light source included in the transmitter in such a way that the modulating part is irradiated with light.

9. A communication device comprising:
a transmission device including the transmitter according to claim 1;
a reception device configured to receive a spatial optical signal from another communication device; and
a communication control device comprising
a second memory storing instructions; and
a second processor connected to the second memory and configured to execute the instructions to
acquire a signal based on the spatial optical signal received by the reception device,
execute processing associated with the acquired signal, and
cause the transmission device to transmit a spatial optical signal obtained by the executed processing.

10. A communication system comprising:
a plurality of communication devices each according to claim 9, wherein
the plurality of communication devices are arranged to transmit and receive the spatial optical signals to and from each other.
